(19) United States
(12) Patent Application Publication
(10) Pub. No.: US 2011/0055227 A1
(43) Pub. Date: Mar. 3, 2011

(54) CONFERENCE RELAY APPARATUS AND CONFERENCE SYSTEM

(75) Inventor: Daisuke IGARASHI, Osaka-shi (JP)

(73) Assignee: SHARP KABUSHIKI KAISHA, Osaka-shi (JP)

(21) Appl. No.: 12/856,753

(22) Filed: Aug. 16, 2010

(30) Foreign Application Priority Data
Aug. 31, 2009 (JP) 2009-200948

(51) Int. Cl. G06F 17/30; G06F 15/173

(52) U.S. Cl. 707/750; 709/224; 707/748; 707/E17.014

(57) ABSTRACT

When having obtained sound singles transmitted/received among plural terminal apparatuses, a sound recognition unit of a conference server performs a sound recognition processing on the obtained sound signals and then generates text information. A language analyzing unit of the conference server performs a language analysis processing on the text information generated by the sound recognition unit and then disassembles the text information into words. A deciding unit of the conference server compares the disassembled words and a keyword database, and decides whether or not any keyword stored in the keyword database is contained in each sentence of speech contents of respective speakers. A totalizing unit calculates a cumulative score based on the decision result of the deciding unit which represents a state of a discussion, and then it is decided in accordance with the calculated cumulative score whether or not the discussion matches to the subject.

### CROSS-REFERENCE TO RELATED APPLICATIONS

This Nonprovisional application claims priority under 35 U.S.C. §119(a) on Patent Application No. 2009-200948 filed in Japan on Aug. 31, 2009, the entire contents of which are hereby incorporated by reference.

### BACKGROUND

1. Technical Field

The present invention relates to a conference relay apparatus for relaying a teleconference performed among plural communicating apparatuses which are connected to each other, and to a conference system provided with the conference relay apparatus.

2. Description of Related Art

It is well known about TV conference system configured with TV conference terminals which are positioned at plural bases and are connected to each other through a network. Such the TV conference system implements a conference performed by participants at separate bases. In addition, it is known about apparatus for comprehending presented time of each conference material utilized at a conference, speech time of each participant at the conference, a conference material presented when a participant gives a speech, and the like (e.g., Japanese Patent Application Laid-Open No. 11-272679). This Japanese Patent Application Laid-Open No. 11-272679 discloses an apparatus that stores respective information described above for comprehending speech state of each participant at a conference. Further, this Japanese Patent Application Laid-Open No. 11-272679 discloses an invention for comprehending activity of discussion with utilizing respective information described above.

### SUMMARY

The apparatus disclosed by Japanese Patent Application Laid-Open No. 11-272679 utilizes speech frequencies of each participant at the conference for comprehending the activity of discussion, however fails to consider contents of respective speech. Therefore, it happens to be comprehended that the discussion is active, even in the case that participants frequently give speeches at the conference but the contents of speeches are strayed from the subject.

The present invention is made in view of such circumstances, and has an object to provide a conference relay apparatus and a conference system for comprehending conference state, e.g., whether discussion of the conference is strayed from the subject or not, in consideration of contents of speeches given by the participants at the conference.

A conference relay apparatus according to the present invention is connected with plural communicating apparatuses to perform communications, relays a teleconference performed among the plural communicating apparatuses, and comprises: a storage unit that stores plural keywords; a deciding unit that decides whether or not any keyword stored in the storage unit is contained in information transmitted/received among the communicating apparatuses; and a state comprehending unit that comprehends a state of the teleconference on the basis of a result decided by the deciding unit.

In an aspect of the present invention, a conference relay apparatus relays a teleconference performed among plural communicating apparatuses that are connected to perform communications. The conference relay apparatus stores plural keywords in the storage unit, and decides whether or not any keyword stored in the storage unit is contained in information transmitted/received among the communicating apparatuses. Furthermore, the conference relay apparatus comprehends a state of the teleconference based on the decision result. Specifically, the conference relay apparatus previously stores a keyword in the storage unit, which is expected to be transmitted/received for the teleconference. Then, the conference relay apparatus determines about the state, e.g., whether or not a discussion of the teleconference is strayed from the subject, on the basis of the presence or the absence of any keyword in the actual information transmitted/received for the teleconference, while the keyword is expected to be transmitted/received for the teleconference and is previously stored in the storage unit. Therefore, the conference relay apparatus can comprehend the state of the conference and determine whether or not the discussion of the conference is strayed from the subject, in consideration of contents of speeches among participants at the conference.

A conference relay apparatus according to the present invention comprises a calculating unit that calculates a cumulative score, based on a score in the case that the deciding unit decides that any keyword stored in the storage unit is contained in the information and on a score in the case that the deciding unit decides any keyword stored in the storage unit is not contained in the information, and the state comprehending unit comprehends the state of the teleconference on the basis of the cumulative score calculated by the calculating unit.

In an aspect of the present invention, a conference relay apparatus calculates a cumulative score through adding different scores between the case that any keyword stored in the storage unit is decided to be contained in information transmitted/received among communicating apparatuses and the case that any keyword stored in the storage unit is decided not to be contained in the information transmitted/received among the communicating apparatuses. Furthermore, the conference relay apparatus comprehends the state, i.e., whether or not a discussion of a teleconference is strayed from the subject on the basis of the calculated cumulative score. Therefore, the conference relay apparatus can utilize numbers corresponding to the situation, i.e., the presence or the absence of any keyword in the information transmitted/received among the communicating apparatuses, for determining whether or not a discussion of the teleconference is strayed from the subject, and then can comprehend the state of the conference more properly.

A conference relay apparatus according to the present invention is a conference relay apparatus, in which information transmitted/received among the communicating apparatuses contains sound information, and which comprises a sound recognizing unit that recognizes and converts the sound information contained in the information transmitted/received among the communicating apparatuses, into text information, and the deciding unit decides whether or not any of the keywords is contained in the text information converted by the sound recognition unit.

In an aspect of the present invention, a conference relay apparatus recognizes, obtains and converts sound information into text information, when relaying sound information as information transmitted/received among communicating apparatuses. The conference relay apparatus decides whether or not the converted text information contains any keyword stored in a storage unit, and then comprehends a state of a teleconference based on the decision result. Therefore, the conference relay apparatus can determine about the state, e.g., whether or not a discussion of the teleconference is strayed from the subject, on the basis of the presence or the absence of any pre-stored keyword in the actual information transmitted/received for the teleconference.

A conference relay apparatus according to the present invention is a conference relay apparatus, in which information transmitted/received among the communicating apparatuses contains text information, and the deciding unit decides whether or not any of the keywords is contained in the text information transmitted/received among the communicating apparatuses.

In an aspect of the present invention, a conference relay apparatus decides whether or not obtained text information contains any keyword previously stored in a storage unit, when relaying text information as information transmitted/received among communicating apparatuses, and then comprehends a state of a teleconference based on the decision result. Therefore, the conference relay apparatus can determine about the state, e.g., whether or not a discussion of the teleconference is strayed from the subject, on the basis of the presence or the absence of any previously stored keyword in the actual information transmitted/received for the teleconference.

A conference relay apparatus according to the present invention comprises a synonym storage unit that stores synonyms of keywords stored in the storage unit, and the deciding unit decides whether or not any of the keywords stored in the storage unit and the synonyms stored in the synonym storage unit is contained in the information transmitted/received among the communicating apparatuses.

In an aspect of the present invention, a conference relay apparatus stores in the synonym storage unit a synonym of a keyword stored in the storage unit. The conference relay apparatus decides whether or not information transmitted/received among communicating apparatuses contains any of the keywords stored in the storage unit or any of the synonyms stored in the synonym storage unit, and then comprehends a state of a teleconference based on the decision result. Therefore, the conference relay apparatus can determine about the state, e.g., whether or not a discussion of the teleconference is strayed from the subject, on the basis of the presence or the absence of not only any previously stored keyword, but also synonym of the keyword, in the actual information transmitted/received for the teleconference.

A conference relay apparatus according to the present invention comprises a notifying unit that notifies a result comprehended by the state comprehending unit.

In an aspect of the present invention, a conference relay apparatus notifies a comprehended state of a conference. Therefore, the conference relay apparatus can report the state, e.g., whether or not a teleconference is strayed from the subject, to participants at the conference.

A conference relay apparatus according to the present invention is a conference relay apparatus, in which the state comprehending unit determines whether or not the state of the teleconference is strayed from a predetermined content including the keyword, and which comprises a reporting unit that reports an intention that the state of the teleconference should match to the predetermined content, in the case that the state of the teleconference is determined by the state comprehending unit to be strayed from the predetermined content.

In an aspect of the present invention, a conference relay apparatus determines whether or not a state of a teleconference is strayed from a predetermined content including a keyword previously stored in the storage unit. When having determined that the state of the teleconference is strayed from the predetermined content, the conference relay apparatus can alert participants at a conference for causing the participants to perform discussions based on the subject.

A conference relay apparatus according to the present invention comprises an extracting unit that extracts a word from the information transmitted/received among the communicating apparatuses, an occurrence frequency counting unit that counts an occurrence frequency of the word extracted by the extracting unit, and a registering unit that registers a word whose occurrence frequency counted by the occurrence frequency counting unit is not less than a predetermined number, as a keyword, in the storage unit.

In an aspect of the present invention, a conference relay apparatus counts an occurrence frequency of a word extracted from information that is transmitted/received among communication apparatuses, and registers a word, as a keyword, whose occurrence frequency is not less than a predetermined number of times. Therefore, the conference relay apparatus can utilize a word as the keyword whose occurrence frequency becomes not less than the predetermined number of times at a teleconference, even which is not stored previously as the keyword.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view showing a configuration of a conference system according to an Embodiment 1.

FIG. 2 is a block diagram showing an internal configuration of a terminal apparatus.

FIG. 3 is a block diagram showing an internal configuration of a conference server.

FIG. 4A, FIG. 4B and FIG. 4C are schematic views showing data contents of tables stored in a storage unit.

FIG. 5A and FIG. 5B are schematic views showing data contents of tables stored in the storage unit.

FIG. 6 is a block diagram showing a functional configuration of the conference server according to the Embodiment 1.

FIG. 7 is a flowchart showing a procedure of relay processing for a teleconference performed by the conference server.

FIG. 8 is a flowchart showing a procedure of relay processing for the teleconference performed by the conference server.

FIG. 9 is a flowchart showing a procedure of relay processing for the teleconference performed by the conference server.

FIG. 10A, FIG. 10B and FIG. 10C are schematic views showing examples of screens displayed by the terminal apparatus.

FIG. 11 is a flowchart showing a procedure of discussion decision processing performed by the conference server.

FIG. 12 is a flowchart showing a procedure of discussion decision processing performed by the conference server.

FIG. 13 is a schematic view showing an example of decision results.

FIG. 14 is a block diagram showing a functional configuration of the conference server according to an Embodiment 2.

FIG. 15 is schematic view showing data contents of a speech content DB.

FIG. 16 is a flowchart showing a procedure of keyword registration processing performed by the conference server.

FIG. 17 is a block diagram showing a functional configuration of the conference server according to an Embodiment 3.

FIG. 18 is a flowchart showing a procedure of keyword registration processing performed by the conference server.

### DETAILED DESCRIPTION

Hereinafter, embodiments of a conference relay apparatus and a computer program according to the present invention are described in detail with reference to drawings. Each embodiment described below is illustrated to be a configuration that implements the conference relay apparatus according to the present invention, by causing a personal computer, a server computer or the like to read the computer program according to the present invention, and then by causing a central processing unit (CPU) or the like of the personal computer or the server computer to execute the read program. Alternatively, the conference relay apparatus according to the present invention may be implemented with hardware working similarly.

### Embodiment 1

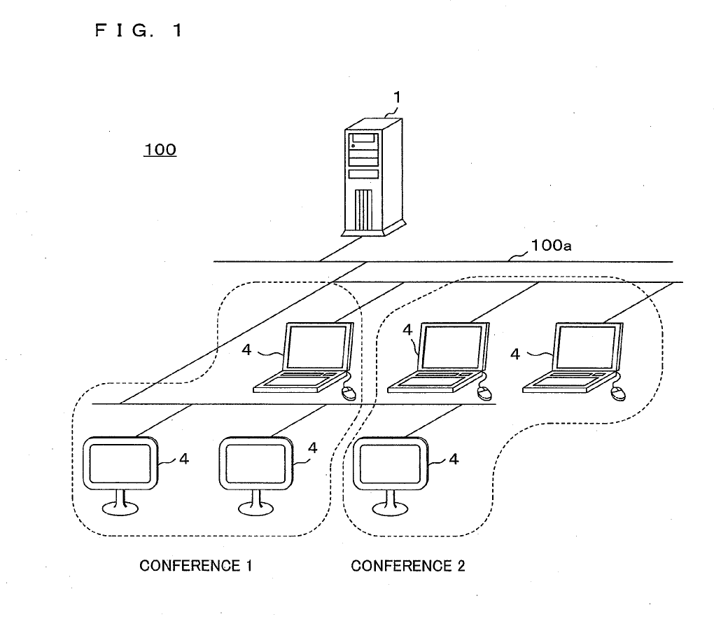

It will be described below about a conference system according to an Embodiment 1 that is provided with the conference relay apparatus according to the present invention. FIG. 1 is a schematic view showing a configuration of the conference system according to the Embodiment 1. The conference system 100 according to the Embodiment 1 includes plural terminal apparatuses (communicating apparatuses) 4, 4, . . . , and a conference server (conference relay apparatus) 1 that relays a teleconference performed among some or all of the terminal apparatuses 4, 4, . . . . In FIG. 1, the conference server 1 is illustrated to relay a conference 1 and a conference 2 independently, which are respectively performed among three terminal apparatuses 4, 4, 4 within closed curves of broken lines.

The terminal apparatuses 4, 4, . . . and the conference server 1 are connected to each other through an internet protocol (IP) network 100a, such as a local area network (LAN) or a wide area network (WAN). In addition, the terminal apparatuses 4, 4, . . . and the conference server 1 transmit/receive various signals, which include sound signals and image signals, based on a communication protocol, such as H. 323, T. 120, session initial protocol (SIP) or hyper text transfer protocol (HTTP). Alternatively, the terminal apparatuses 4, 4, . . . and the conference server 1 may utilize a proper combination of these communication protocols.

In the conference system 100 according to the Embodiment 1, the terminal apparatuses 4, 4, . . . and the conference server 1 are connected to each other through the IP network 100a. Alternatively, the terminal apparatuses 4, 4, . . . may not be connected to each other, but each of the terminal apparatuses 4, 4, . . . may be connected to the conference server 1 in order to perform one-to-one communication. Alternatively, one terminal apparatus 4 may be provided with a function of the conference server 1, said one terminal apparatus 4 may be treated as a base apparatus, and the other terminal apparatuses 4, 4, . . . may be respectively connected to said one terminal apparatus 4, in order to perform one-to-one communication with said one terminal apparatus.

In the conference system 100 according to the Embodiment 1, it is assumed to position all the terminal apparatuses 4, 4, . . . in the same room and to cause all the terminal apparatuses 4, 4, . . . to participate in the same teleconference. In other words, it is assumed to prepare terminal apparatuses 4, 4, . . . in the same room, as much as the number of participants of the same conference, and to provide with one terminal apparatus 4 to each participant in order to participate in the conference. While causing own terminal apparatuses 4, 4, . . . to display conference material, respective participants hear speeches of a chairman or a speaker, and participate in the conference. Alternatively, not all the terminal apparatuses 4, 4, . . . may be positioned in the same room, but some terminal apparatuses 4, 4, . . . may be positioned at a different place. In this alternative case, the conference system 100 according to the Embodiment 1 can be utilized for teleconference among separated places.

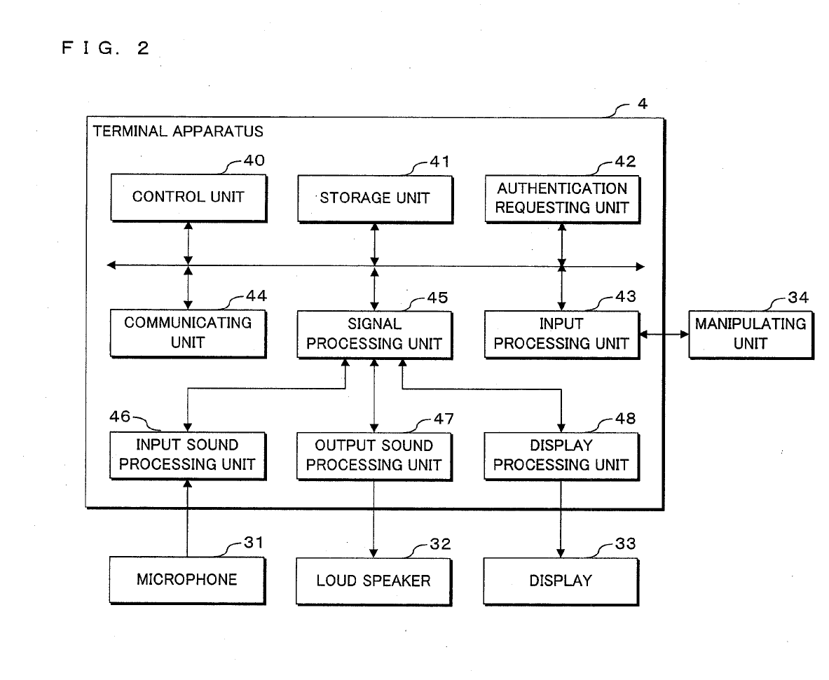

It will be described below about the terminal apparatus 4 utilized in the conference system 100 according to the Embodiment 1. FIG. 2 is a block diagram showing an internal configuration of the terminal apparatus 4. The terminal apparatus 4 according to the Embodiment 1 includes a control unit 40, a storage unit 41, an authentication requesting unit 42, an input processing unit 43, a communicating unit 44, a signal processing unit 45, an input sound processing unit 46, an output sound processing unit 47, a display processing unit 48, and the like. The control unit 40, the storage unit 41, the authentication requesting unit 42, the input processing unit 43, the communicating unit 44 and the signal processing unit 45 are mutually connected through a bus. In addition, the input sound processing unit 46, the output sound processing unit 47 and the display processing unit 48 are respectively connected to the signal processing unit 45.

The control unit 40 is a CPU, a micro processor unit (MPU) or the like, controls respective hardware units as described above, and properly executes control programs stored in the storage unit 41. The storage unit 41 is an electrically erasable and programmable ROM (EEPROM), a flash ROM, a hard disk drive (HDD) or the like. The storage unit 41 stores various control programs required for implementing the terminal apparatus 4, various data generated due to the control programs executed by the control unit 40, a terminal ID and an IP address assigned to own terminal apparatus 4, and the like. The storage unit 41 stores, e.g., a TV conference processing program for performing a TV conference through the conference server 1, a document browsing program for browsing common documents stored in external apparatuses including the conference server 1, and the like.

The authentication requesting unit 42 requests the conference server 1 to perform an authentication of a participant who utilizes the terminal apparatus 4 and wants to participate in a teleconference provided by the conference system 100. Specifically, when having received an user ID and a password through manipulating unit 34, the authentication requesting unit 42 transmits the received user ID and password from the communicating unit 44 to the conference server 1, in order to request the conference server 1 to perform the authentication. In addition, the authentication requesting unit 42 obtains the authentication result through the communication unit 44 from the conference server 1, and then reports the obtained authentication result to the control unit 40.

The input processing unit 43 is connected to the manipulating unit 34 and obtains various information being input by a user through the manipulating unit 34. The manipulating unit 34 is a mouse, a keyboard, a tablet or the like, and is provided with various buttons required for user's manipulation on the terminal apparatus 4. The input processing unit 43 transmits various information to the control unit 40, as the information is input by the user through the manipulating unit 34. The control unit 40 receives the information from the input processing unit 43, and then performs processing corresponding to the received information. The communicating unit 44 is an interface for connecting the terminal apparatus 4 to the IP network 100a, and performs information transmission/reception with the conference server 1 through the IP network 100a.

The input sound processing unit 46 is connected to a microphone 31. The input sound processing unit 46 includes, e.g., an analog/digital (A/D) converter, converts analog sound signals collected by the microphone 31 into digital sound signals, and then outputs the converted digital sound signals to the signal processing unit 45. The signal processing unit 45 includes a sound encoder that encodes sound signals, and encodes the sound signal obtained from the input sound processing unit 46. For example, the sound signal encoded by the signal processing unit 45 is transferred to the communicating unit 44 and the communicating unit 44 transmits the encoded sound signal to the conference server 1. Thus, the microphone 31 of the terminal apparatus 4 collects sound signals, and the collected sound signals are transmitted to the conference server 1. The sound encoder performs encoding processes based on rules, such as the G. 711, the G. 722, the G. 728, the G729, and the moving picture experts group (MPEG)-4 advanced audio coding (AAC).

The signal processing unit 45 includes a sound decoder that decodes the encoded sound signals. The communicating unit 44 receives the encoded sound signals from the conference server 1 through the IP network 100a. The signal processing unit 45 decodes the encoded sound signals obtained from the communicating unit 44. The sound decoder performs decoding processes based on the same rules on which the encoding processes performed by the sound encoder are based. The signal processing unit 45 outputs the sound signals to the output sound processing unit 47, which have been obtained from the communicating unit 44 and then decoded. The output sound processing unit 47 is connected to a loud speaker 32. The output sound processing unit 47 includes, e.g., a digital/analog (D/A) converter, converts digital sound signals obtained from the signal processing unit 45 into analog sound signals, and then outputs the converted analog sound signals to the loud speaker 32. Therefore, it is possible to output sounds from the loud speaker 32, as the output sounds are based on the sound signals received from the conference server 1.

The signal processing unit 45 includes an image decoder that decodes such the encoded image signals. The communicating unit 44 receives the encoded image signals from the conference server 1 through the IP network 100a, and the signal processing unit 45 decodes the encoded image signals obtained from the communicating unit 44. The image decoder performs decoding processes based on the rules, such as the H. 261, the H. 263, and the H. 264. The signal processing unit 45 obtains the image signals from the communicating unit 44, decodes the obtained image signals and then outputs the decoded image signals to the display processing unit 48. The display processing unit 48 is connected to a display 33, and outputs the image signals obtained from the signal processing unit 45 to the display 33. Therefore, it is possible to show images on the display 33 which are based on the image signals received from the conference server 1. The display 33 is a liquid crystal display (LCD), a cathode ray tube (CRT), a plasma display panel (PDP) or the like.

Although the microphone 31, the loud speaker 32, the display 33 and the manipulating unit 34 described above are respectively configured to be physically separated from the terminal apparatus 4 itself, they may be alternatively configured to be included in the terminal apparatus 4. In addition, the display 33 and the manipulating unit 34 may be configured with touch panels or tablets.

In the Embodiment 1, it is configured that the participants of the conference manipulate the terminal apparatuses 4, 4, . . . in the same room. Thus, it is not required to take pictures of faces of participants who utilize the respective terminal apparatuses 4, 4, . . . . However, in the case the conference system 100 is utilized for teleconference, the terminal apparatuses 4, 4, . . . are positioned at separated places. Therefore, cameras may be connected to the terminal apparatuses 4, 4, . . . , and then the terminal apparatuses 4, 4, . . . may be respectively provided with image processing units that perform processes on the image signals obtained by the cameras. The image processing unit is, e.g., an image encoder that encodes the image signal obtained by the camera, and the image encoder performs encoding processes based on the rules, such as the H. 261, H. 263 and the H264.

The participants of the conference in the Embodiment 1 are assumed to manipulate the terminal apparatuses 4, 4, . . . in the same room. At the conference where all participants are within a predetermined area similar to this assumption, all the participants can directly hear sounds of speeches. Therefore, in the case that the conference system 100 is applied to such the conference, the loud speaker 32 may not be required to each of the terminal apparatuses 4, 4, . . . . The conference server 1 according to the Embodiment 1 has a function to comprehend activity of the discussion, and thus the microphone 31 must be provided to each of the terminal apparatuses 4, 4, . . . , for working the function.

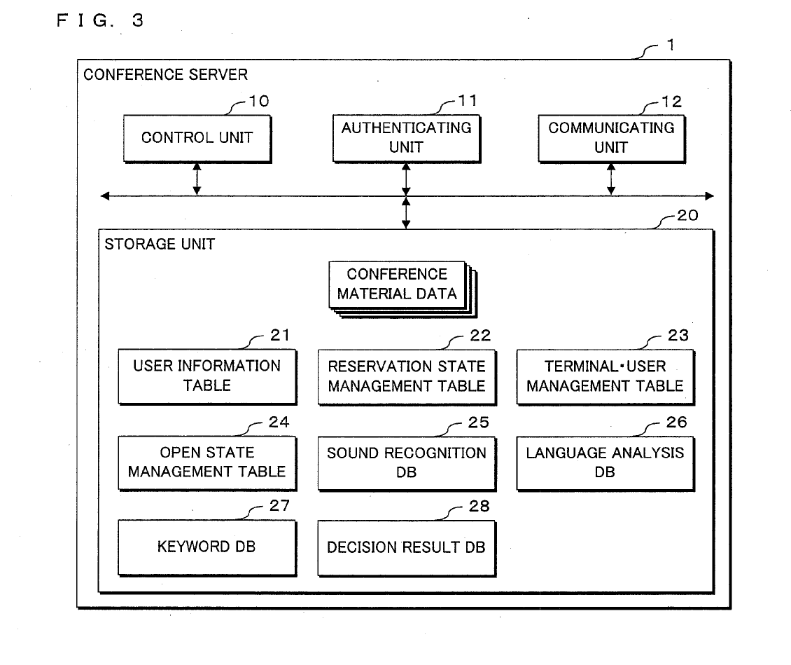

It will be described below about the conference server 1 utilized in the conference system 100 according to the Embodiment 1. FIG. 3 is a block diagram showing an internal configuration of the conference server 1. The conference server 1 according to the present invention includes a control unit 10, an authenticating unit 11, a communicating unit 12, a storage unit 20 and the like. Respective hardware portions described above are connected with each other through a bus. The control unit 10 is a CPU, a MPU or the like, controls the respective hardware portions described above, and properly executes control programs stored in the storage unit 20.

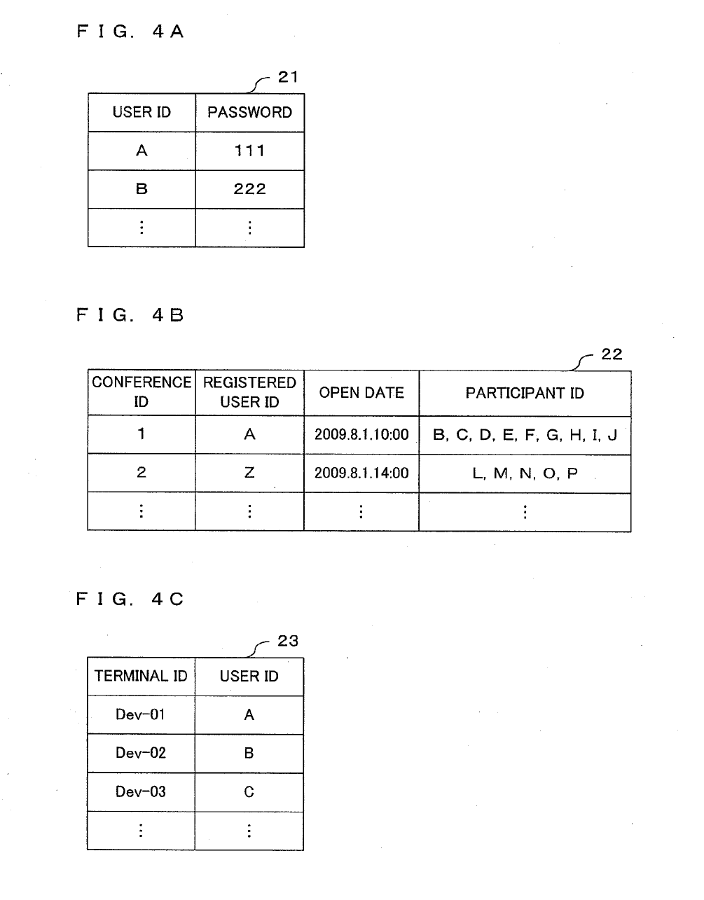

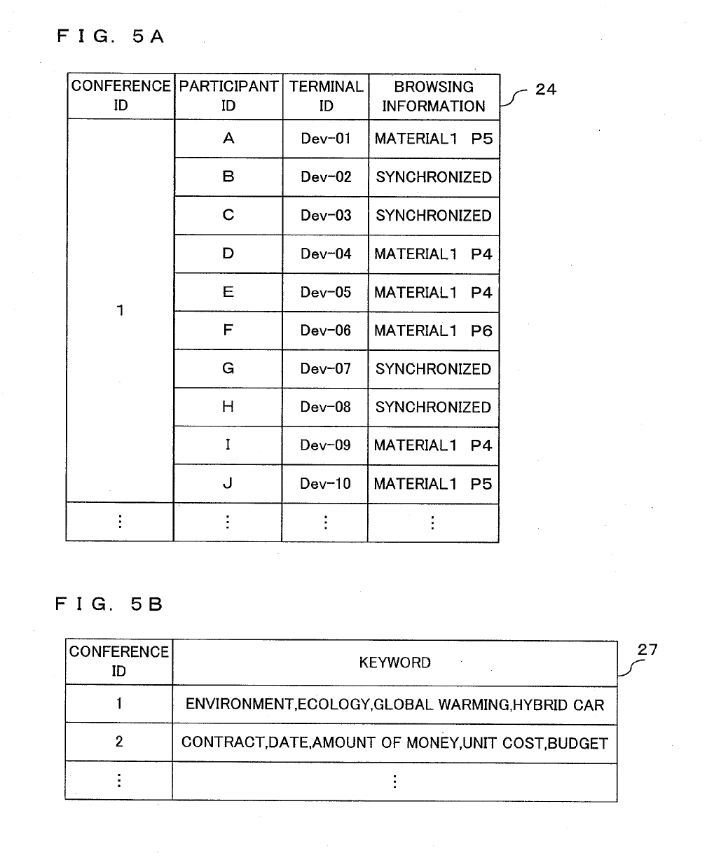

The storage unit 20 is a large-capacity storage device, such as a HDD. The storage unit 20 stores various control programs required for implementing the conference server 1, and various data generated due to the control programs executed by the control unit 10. The conference server 1 according to the Embodiment 1 has a web server function, and stores information about web pages published through the IP network 100a in the storage unit 20. Further, the storage unit 20 stores data of conference materials shared (published) through the IP network 100a, an user information table 21 as shown by FIG. 4A, a reservation state management table 22 as shown in FIG. 4B, a terminal-user management table 23 as shown in FIG. 4C, and an open state management table 24 as shown in FIG. 5A.

The storage unit 20 stores a sound recognition processing program for the sound recognition processing performed by the control unit 10 in order to convert the sound signals into the text information, and stores database dedicated to the sound recognition processing (i.e., sound recognition DB) 25. The storage unit 20 stores a language analysis processing program for the sound analysis processing performed by the control unit 10 in order to disassemble text information into words based on Japanese grammar, and a data base dedicated to the language analysis processes (i.e., language analysis DB) 26. Further, the storage unit 20 stores decision processing programs for the decision processing performed by the control unit 10 in order to decide whether or not a discussion at the teleconference is strayed from the subject, stores keyword database (i.e., keyword DB) 27 about keywords utilized for the decision processes, and stores decision result database (i.e., decision result DB) 28.

The conference material data is document data, image data and the like, and is published through the IP network 100a, and then the terminal apparatuses 4, 4, . . . can browse the conference material data. Alternatively, the conference material data may be published only for specific users. In this alternative case, the conference server 1 may store user information (user ID) of users who are allowed to browse the conference material data, and may allow users who have requested browsing through the IP network 100a and whose user information have been previously stored. Although the storage unit 20 stores several tables, it will be described later about the details of the tables.

The authenticating unit 11 obtains user IDs and passwords through the communicating unit 12, which have been input through the manipulating unit 34 of the terminal apparatus 4 and transmitted from the authentication requesting unit 42 of the terminal apparatus 4. The authenticating unit 11 performs the authentication processing whether or not an user (participant) is a proper authenticated participant allowed utilizing the conference system 100, on the basis of the decision result whether the obtained user ID and password are previously registered on the user information table 21 described later. In the case that the obtained user ID and password have been registered on the user information table 21, the authenticating unit 11 determines that the user is the proper authenticated participant. In the case that the obtained user ID and password have not been registered on the user information table 21, the authenticating unit 11 determines that the user is not the proper authenticated participant. The authenticating unit 11 transmits both the obtained user ID and the authentication result back to the terminal apparatus 4 from which the user ID and password has been transmitted.

The communicating unit 12 is an interface for connecting to the IP network 100a, and performs information transmission/reception with the terminal apparatuses 4, 4, . . . through the IP network 100a.

FIG. 4A, FIG. 4B, FIG. 4C, FIG. 5A and FIG. 5B are schematic views showing data contents of tables stored in the storage unit 20. FIG. 4A illustrates data contents of the user information table 21. FIG. 4B illustrates data contents of the reservation state management table 22. FIG. 4C illustrates data contents of the terminal-user management table 23. FIG. 5A illustrates data contents of the open state management table 24. FIG. 5B illustrates data contents of the keyword DB 27.

As shown in FIG. 4A, the user information table 21 stores user information about users who are allowed to utilize the conference system 100 that is provided by the conference server 1. For example, the user information includes user IDs previously assigned to respective users, passwords registered by respective users, and the like. Another information may be utilized as the user information which can be utilized for identifying respective users and for performing the authentication processing whether respective users are authenticated or not. About respective users, the user information may include names, affiliations, positions and the like. The data contents of the user information table 21 are registered, updated or deleted by the control unit 10, every time when user information is added, changed or deleted about users who can utilize the conference system 100. The user information is input into the conference server 1 through a manipulating unit (not shown) of the conference server 1, a manipulating unit of the terminal apparatus 4 connected to the conference server 1 via the IP network 100a or a manipulating unit of another communicating apparatus. Therefore, the conference server 1 can manage users who can utilize the conference system 100, in accordance with the user information table 21.

As shown in FIG. 4B, the reservation state management table 22 stores reservation information of a conference (teleconference) opened by the conference system 100. The reservation information include conference IDs assigned to reserved conferences, user IDs (registered user IDs) about users (registered users) who reserve the conferences, open date of the reserved conferences, user IDs (participant IDs) about users (participants) who participate in the reserved conferences, and the like. The data contents of the reservation state management table 22 are registered or deleted by the control unit 10, every time when a user allowed to utilize the conference system 100 reserves a conference to be opened or cancel the reservation. The reservation information stored in the reservation state management table 22 is updated by the control unit 10, every time when a registered user changes a detail of the reservation. The reservation information is also input into the conference server 1 through the manipulating unit of the conference server 1, the manipulating unit of the terminal apparatus 4 or the manipulating unit of another communicating apparatus. Therefore, the conference server 1 can manage conference reservations based on such the reservation state management table 22.

As shown in FIG. 4C, the terminal-user management table 23 stores user IDs about users who are utilizing respective terminal apparatuses 4, 4, . . . , in association with terminal IDs assigned to respective terminal apparatuses 4, 4, . . . . The terminal-user management table 23 previously stores terminal IDs assigned to terminal apparatuses 4, 4, . . . that are utilized for the conference system 100. The terminal IDs stored in the terminal-user management table 23 may be alternatively IDs assigned to only currently activated terminal apparatuses 4, 4, . . . among all the terminal apparatuses 4, 4, . . . utilized for the conference system 100. A user ID is stored in the terminal-user management table 23 by the control unit 10 in correspondence to the terminal ID of the terminal apparatus 4 through which the user logs in the conference server 1 in order to utilize the conference system 100. When the user utilizing the conference system 100 logs out from the conference server 1, the corresponding user ID is deleted from the terminal-user management table 23 by the control unit 10. Therefore, the conference server 1 can identify the terminal apparatus 4 currently utilized by the user of the conference system 100, based on the terminal-user management table 23.

As shown in FIG. 5A, the open state management table 24 stores participant information about users (participants) who participate in respective conferences in association with conference IDs assigned to respective conferences (teleconferences) currently opened by the conference system 100. The participant information include user IDs (participant IDs) of respective conferences, terminal IDs of terminal apparatus 4 currently utilized by respective participants, browsing information representing conference materials currently browsed by respective participants, and the like. When any of registered users and participants whose information is registered into the reservation information tries to log in the conference server 1 in order to participate in a conference, the corresponding participant information is registered on the open state management table 24 by the control unit 10 in association with the conference IDs. After the participant information about the participant who firstly logs in is registered on the open state management table 24, respective following participant information is additionally stored every time when respective following and corresponding participants log in the conference server 1. At the time when respective participants (including registered users) try to log in the conference server 1, only the participant IDs and the terminal IDs about the respective participants are stored in the open state management table 24.

The browsing information stored in the open state management table 24 is updated by the control unit 10, every time when the conference server 1 provides conference material data in response to each request from the participant (terminal apparatus 4). Therefore, the conference server 1 can manage participants of respective conferences that are currently opened, conference materials that are currently browsed by respective participants and the like, based on the open state management table 24. Alternatively, the first participant information may be registered on the open information management table 24, in association with the corresponding conference ID at the time, e.g., when the registered user having reserved the conference tries to log in the conference server 1.

The sound recognition DB 25 is, e.g., a word dictionary in which a pronounce and a phonemic string are associated with each other for recognition words that are obtained as recognition results of the sound recognition processing, a word dictionary in which sound data (sound signals) are associated with respective recognition words, or the like. The phonemic strings of respective recognition words represent strings in an acoustic model, which indicate respective phonemic features. The sound recognition DB 25 stores an acoustic model (acoustic parameter well utilized in the sound recognition field) which represents features of respective Japanese phonemes. For example, the language analysis DB 26 is a word dictionary that registers representations, pronunciations, parts of speech and the like for respective words and is utilized for morphological analysis.

As shown in FIG. 5B, the keyword DB 27 stores plural keywords that are expected to be spoken by respective participants at discussions of respective reserved conferences, in association with conference IDs corresponding to the reserved conferences. For example, the data contents of the keyword DB 27 are registered or updated by the control unit 10, every time when a registered user who has reserved a conference sets or changes a keyword. The keyword stored in the keyword DB 27 is input into the conference server 1 through the manipulating unit of the conference server 1, the manipulating unit of the terminal apparatus 4 connected to the conference server 1 via the IP network 100a or the manipulating unit of another communicating apparatus. The conference server 1 decides whether or not discussions at respective conferences match to the subject, on the basis of such the keyword DB 27. The keywords are not limited to be registered on the keyword DB 27 only by the input manipulation of the registered user of the conference. For example, the keywords may be automatically extracted from the conference materials and then registered. Such the example will be described later in an Embodiment 3.

The decision result DB 28 stores results of the decision processing performed by the control unit 10 executing the decision processing program stored in the storage unit 20. The decision result DB 28 according to the Embodiment 1 stores information representing whether the discussion matches to or is strayed from the subject, as the decision results, in association with time course since the teleconference is opened. The conference server 1 according to the Embodiment 1 calculates cumulative scores for discussions based on the decision results (whether a discussion matches to or is strayed from the subject). As the cumulative scores are sequentially calculated (updated), the decision result DB 28 stores such the cumulative scores in association with the conference IDs. However, the decision result DB 28 is not limited to be the configuration described above. Alternatively, the decision result DB 28 may accumulate the scores at several time points on the conferences, in association with time course since the teleconferences are opened. Alternatively, the decision result DB 28 may accumulate the decision results (whether a discussion matches to or is strayed from the subject) per predetermined time period since the teleconferences are opened.

Respective information stored in the storage unit 20 is not limited to be previously stored in the storage unit 20. In the case that the conference server 1 has a driver (not shown) capable of reading out data stored in an external memory (not shown), the storage unit 20 may store various information that has been stored in the external memory and has been read out by the driver. Alternatively, the conference server 1 may download various information from an external apparatus, e.g., through an Internet, and may store downloaded information in the storage unit 20.

The conference server 1 may further include a manipulating unit for manipulating the conference server 1 and a displaying unit for displaying results of processing performed by the conference server 1, as well as the hardware portions described above. In this case, an administrator of the conference system 100 can easily change conference material data contents of respective tables and the like stored in the storage unit 20, with utilizing the manipulating unit and the displaying unit.

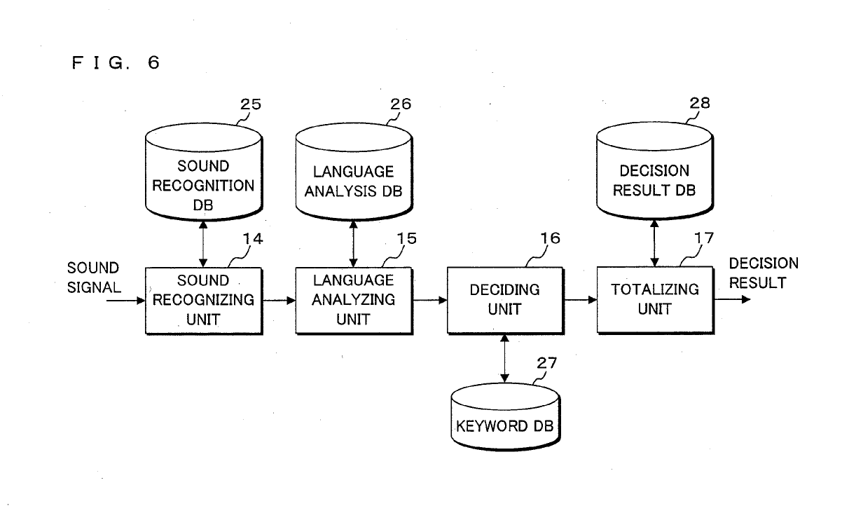

It will be described below about various functions implemented by the control unit 10 executing the control programs stored in the storage unit 20. FIG. 6 is a block diagram showing a functional configuration of the conference server 1 according to the Embodiment 1. In the conference server 1 according to the Embodiment 1, the control unit 10 executes the control programs stored in the storage unit 20, and then implements a sound recognizing unit 14, a language analyzing unit 15, a deciding unit 16, a totalizing unit 17 and the like.

For example, the sound recognizing unit 14 performs sound recognition processing on the sound signals received through the communicating unit 12, with utilizing the sound recognition DB 25, and then converts the processed sound signals into the text information. Specifically, the sound recognizing unit 14 performs sound analysis processing on the sound signals, extracts acoustic parameters, compares with the acoustic models stored in the sound recognition DB 25, and finds words corresponding to the closest acoustic model, as the recognition results. The sound recognizing unit 14 outputs the text information obtained by the sound recognition processing to the language analyzing unit 15.

The language analyzing unit 15 performs language analysis processing on the text information generated by the sound recognizing unit 14 with utilizing the language analysis DB 26. For example, the language analysis processing is the morphological analysis and disassembles the text information into words. The language analyzing unit 15 separates the text information being input from the sound recognizing unit 14 by each sentence, pools words obtained by the language analysis processing per one sentence, and outputs the pooled words to the deciding unit 16.

The deciding unit 16 obtains words per one sentence which are generated by the disassembling processing of the language analyzing unit 15, compares the words per one sentence with keywords stored in the keyword DB 27, and decides whether each sentence contains any keyword or not. The deciding unit 16 reports the decision result (whether each sentence contains any keyword or not) to the totalizing unit 17.

When having been reported the decision result from the deciding unit 16, the totalizing unit 17 accumulates the decision result in the decision result DB 28 in association with time course since the conference is opened. The control unit 10 has a clock function for measuring time course since each conference is opened. In addition, the totalizing unit 17 adds a score corresponding to the reported decision result onto the cumulative score stored in the decision result DB 28 in association with each conference ID. For example, the totalizing unit 17 adds “+1” to the cumulative score when having been reported by the deciding unit 16 that each sentence contains a keyword. For example, the totalizing unit 17 adds “−1” to the cumulative score when having been reported by the deciding unit 16 that each sentence contains no keyword.

The totalizing unit 17 may perform weighting processing on the score in the case that each sentence is decided to contain a keyword and on the score in the case that each sentence is decided to contain no keyword, and then the scores on which the weighting processing are performed may be added onto the cumulative score. For example, the totalizing unit 17 adds “+3” onto the cumulative score when having been reported by the deciding unit 16 that each sentence contains a keyword. For example, the totalizing unit 17 adds “−2” onto the cumulative score when having been reported by the deciding unit 16 that each sentence contains no keyword. In addition, when each sentence contains plural keywords, the totalizing unit 17 may add higher scores in the case that each sentence contains plural keywords.

The totalizing unit 17 determines whether each discussion of a conference matches to or is strayed from the subject, in reference to the sequentially updated cumulative score. The conference server 1 according to the Embodiment 1 considers whether any keyword previously stored in the keyword DB 27 is contained in the speech contents of respective participants collected by the microphones 31 of the terminal apparatuses 4, 4, . . . , and then determines whether each discussion of a conference matches to or is strayed from the subject, on the basis of the consideration. The totalizing unit 17 compares the cumulative score for each conference and a pre-set threshold value, and determines that the discussion is strayed from the subject in the case that the cumulative score is less than the pre-set value. On the other hand, the totalizing unit 17 determines that the discussion matches to the subject in the case that the cumulative score is not less than the pre-set value.

In the case that the totalizing unit 17 determines that the discussion is strayed from the subject, the control unit 10 of the conference server 1 transmits, e.g., a message “discussion is strayed from subject” through the communicating unit 12 to all terminal apparatuses 4, 4, . . . participating in the conference. In the case that the totalizing unit 17 determines that the discussion matches to the subject, the control unit 10 of the conference server 1 transmits, e.g., a message “discussion matches to subject” through the communicating unit 12 to all terminal apparatuses 4, 4, . . . participating in the conference. Therefore, it is possible to report all the participants whether the discussion of the conference matches to the keywords stored in the keyword DB 27 or not. It should be noted that such the report is not necessarily required in the case that the discussion matches to the subject.

It will be described below about processing performed by the conference server 1 and the terminal apparatuses 4, 4, . . . . In the conference system 100 described above, a user utilizes the terminal apparatus 4 to access the conference server 1 for reserving a conference. It may be configured to perform authentication processing with a user ID and a password at the time the user stars utilizing the terminal apparatus 4, and to limit users who can utilize the terminal apparatus 4 to be users who can utilize the conference system 100.

The conference server 1 has a web server function and prepares a web page for the terminal apparatus 4 in order to receive a reservation of a conference provided by the conference system 100. The web page for receiving a conference reservation (not shown) contains input fields for reservation information, such as a user ID identifying a user who reserves a conference, open date of the conference, and a participant ID (user ID) identifying a participant of the conference. The user who reserves the conference inputs reservation information, such as the own user ID (registered user ID), the open date, and the reservation information, and then the control unit 40 of the terminal apparatus 4 transmits the input reservation information to the conference server 1 in order to reserve the conference.

When having obtained the reservation information from the terminal apparatus 4, the control unit 10 of the conference server 1 assigns a conference ID to the reserved conference, and stores the assigned conference ID in the reservation management table 22 in association with the obtained reservation information. Then, the conference reservation is completed. Any information for identifying each conference may be utilized for the conference ID. For example, it may be possible to utilize information “1, 2, 3 . . . ”, as the conference IDs, assigned to the conferences in the order stored in the reservation management table 22.

The user (registered user) who has reserved the conference registers keywords for the conference on the conference server 1 through the terminal apparatus 4. It is possible to register the keywords through the web page prepared by the conference server 1, too. When having obtained the keywords for respective conferences from the terminal apparatus 4, the control unit 10 of the conference server 1 stores the obtained keywords on the keyword DB 27, in association with the conference IDs of the reserved conferences. The keyword is a word, a term or the like that is expected to be spoken by respective participants at the conference. In the Embodiment 1, the keyword is registered by the input manipulation of the registered user for the conference.

It will be described about processing performed by the conference server 1 and the terminal apparatuses 4, 4, . . . at the time of arranging the reserved conference, in the conference system 100 storing the reservation information of respective conferences in the reservation state management table 22 of the conference server 1 as described above. The registered user of the conference has to register the keyword on the keyword DB 27 of the conference server 1 before the conference is opened, and can change the keyword anytime before the conference is opened.

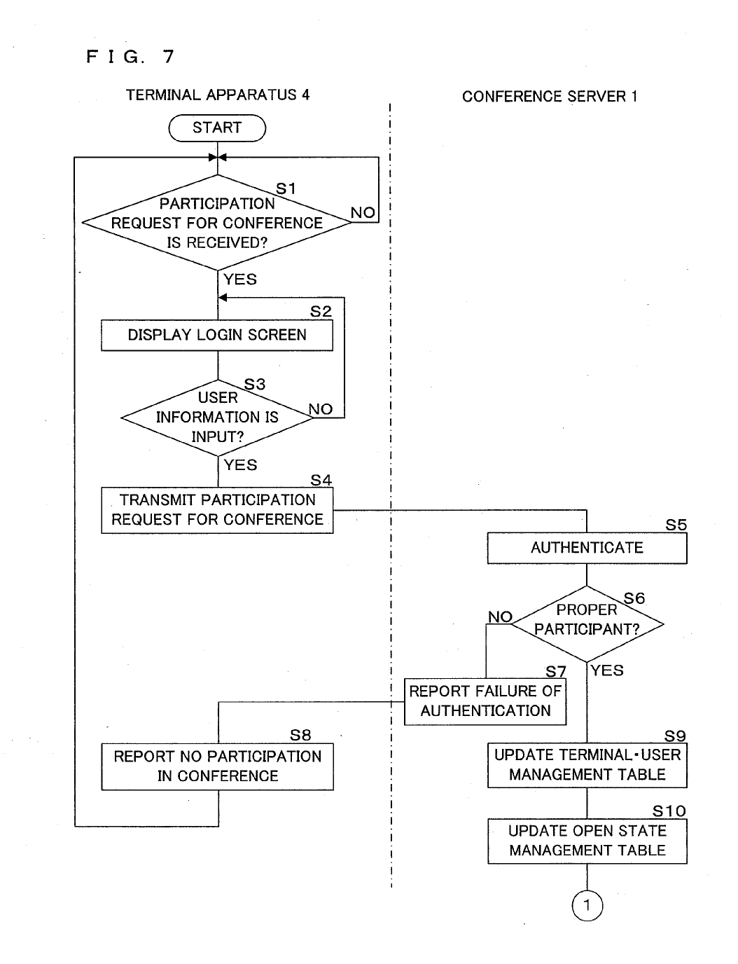

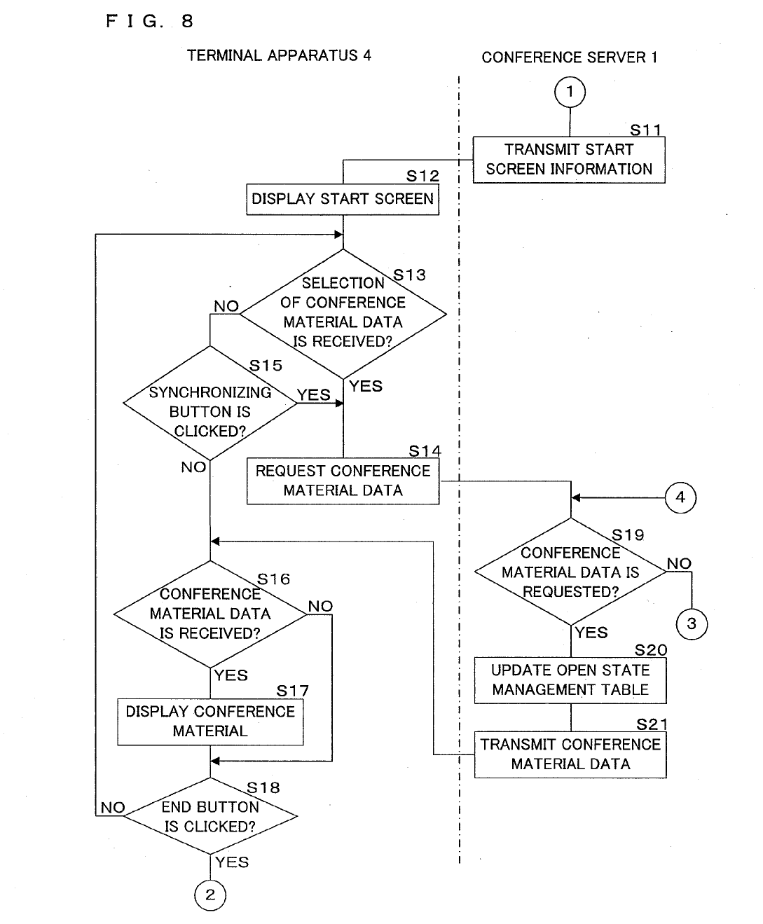

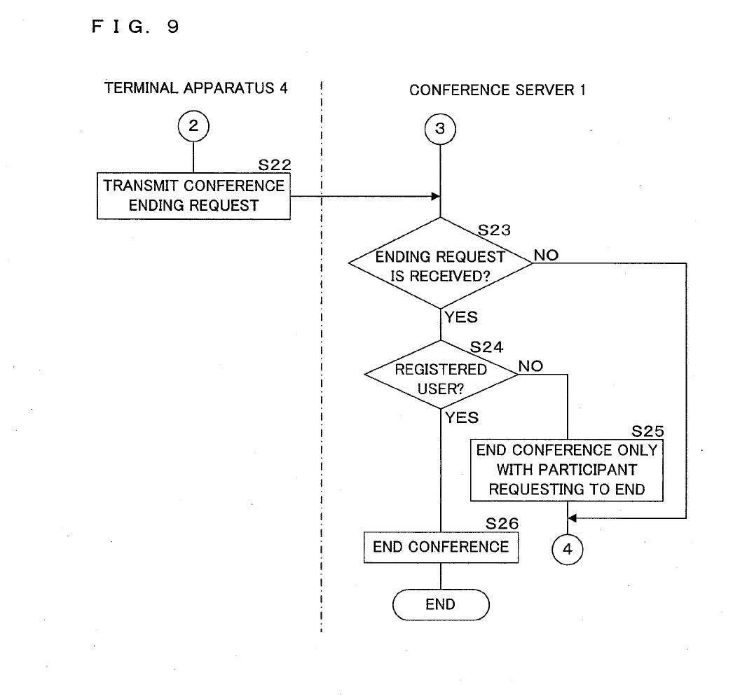

FIG. 7, FIG. 8 and FIG. 9 are flowcharts showing procedures of relay processing for a teleconference performed by the conference server 1. The processing described below is performed by the control unit 10 of the conference server 1 and the control unit 40 of respective terminal apparatuses 4, 4, . . . . As each of FIG. 7, FIG. 8 and FIG. 9 is separated by a broken line into two regions, processing performed by the control unit 40 of the terminal apparatus 4 is illustrated in the left region and processing performed by the control unit 10 of the conference server 1 is illustrated in the right region.

A participant (including a registered user) who wants to participate in a reserved conference accesses to the conference server 1 with utilizing the terminal apparatus 4. The conference server 1 prepares a web page for the terminal apparatus 4 in order to receive a participation request of a reserved conference or of an already-opened conference. For example, the web page for receiving the participation request of the reserved conference or the already-opened conference (not shown) shows a list of information about reserved conferences or already-opened conferences and receives a selected conference among these conferences.

As displaying such the web page on the display 33, the control unit 40 of the terminal apparatus 4 considers whether a participant has selected one conference with the manipulating unit 34 among the information shown in the list, and determines whether having received a participation request for the arbitrary selected conference or not (S1), on the basis of the consideration. When having determined not to receive a participation request for the arbitrary conference (S1: NO), the control unit 40 waits until receiving the participation request for the arbitrary conference. When having determined to receive a participation request for the arbitrary conference already (S1: YES), the control unit 40 displays a login screen on the display 33 (S2) which contains input fields for user IDs and passwords of participants.

The control unit 40 of the terminal apparatus 4 determines whether or not an user ID and a password (user information) are input through the login screen (S3). When having determined that user information is not input yet (S3: NO), the control unit 40 returns the procedure to the step S2 and keeps displaying the login screen. When having determined that user information is input already (S3: YES), the control unit 40 reads out the terminal ID of own terminal apparatus 4 from the storage unit 41, transmits information representing the conference selected at the step S1 (e.g., conference ID), the input user information, and the read terminal ID to the conference server 1 through the communicating unit 44, and then transmits the participation request for the conference (S4).

Alternatively, the authentication processing based on the user information may be performed at the time when the user starts utilizing the terminal apparatus 4 in order to limit users who can request for participating in a conference to be users who can utilize the conference system 100, but not at the time when the participation request for the arbitrary conference is received. In addition, the input field for the user ID on the login screen may be configured with a list of user IDs identifying users previously registered on the conference system 100 which is shown by a pull-down menu. In this configuration, an user who wants to login the conference server 1 can select own user ID from the list shown by the pull-down menu. Therefore, it is possible to reduce the steps for the user ID input manipulation.

When having received the participation request for a conference from the terminal apparatus 4 through the communicating unit 12, the control unit 10 of the conference server 1 authenticates with utilizing the authenticating unit 11 whether the user requesting the participation for the conference is a proper participant allowed to participate in this conference or not (S5). Specifically, the control unit 10 authenticates at first whether this user is allowed to utilize the conference system 100 or not, in accordance with the user information (user ID and password) received from the terminal apparatus 4. At this authentication, the control unit 10 determines whether the received user information has been registered on the user information table 21 already or not. In the case that the received user information has been registered on the user information table 21 already, the control unit 10 determines that this user is the proper user. In the case that the received user information has not been registered on the user information table 21 yet, the control unit 10 determines that this user is not the proper user.

Next, the control unit 10 determines whether or not the user who is determined to be allowed utilizing the conference system 100 is registered as the participant of the conference corresponding to the participation request, in accordance with the conference ID and the user ID received from the terminal apparatus 4. The control unit 10 reads out reservation information corresponding to the received conference ID from the reservation state management table 22, and determines whether or not the received user ID is included in the registered user ID or the participant ID of the read reservation information. In the case that the received user ID is included in the registered user ID or the participant ID of the read reservation information, the control unit 10 determines that the user is a proper participant. In the case that the received user ID is not included in the registered user ID or the participant ID of the read reservation information, the control unit 10 determines that the user is not the proper participant.

The control unit 10 of the conference server 1 determines whether the user requesting to participate in the conference is a proper participant or not, in accordance with the authentication result (S6). When having determined that the user is not the proper participant (S6: NO), the control unit 10 reports the authentication result representing failure of authentication to the terminal apparatus 4 from which the participation request for the conference has been transmitted (S7). In the case that the user requesting the participation for the conference is not the user previously allowed to utilize the conference system 100, or in the case that the user requesting the participation for the conference is not the user registered as the participant for the conference corresponding to the participation request, the control unit 10 determines to be not the proper participant.

When the authentication failure has been reported through the communicating unit 44 from the conference server 1, the control unit 40 of the terminal apparatus 4 causes the display 33 to show a message, such as “wrong user ID/password” or “impossible to participate in the conference”, and reports to the user that it is not allowed to participate in the conference (S8). Then, the control unit 40 returns the procedure to the step S1, and receives participation request for conferences or inputs user information again.

When having determined in accordance with the authentication result that the user requesting to participate in the conference is the proper participant (S6: YES), the control unit 10 of the conference server 1 stores the terminal ID and the user ID received from the terminal apparatus 4 into the terminal-user management table 23 (S9) with the IDs being associated each other. Therefore, in the case that a proper participant tries to access to the conference system 100, it is possible to recognize the terminal apparatus 4 utilized by each participant.

Next, the control unit 10 of the conference server 1 generates participant information for the user (participant) authenticated to be the proper participant, and stores the generated participant information into the open state management table 24 in association with the conference ID received from the terminal apparatus 4 (S10). The open state management table 24 is configured to keep the participant information for the registered user who has reserved the conference as the first participant information in all of the stored participant information for respective participants. Thus, in the case that the user authenticated to be the proper participant is the registered user who has reserved the conference, the control unit 10 stores the generated participant information into a top portion of the region storing the participant information corresponding to the conference ID. On the other hand, in the case that the user authenticated to be the proper participant is not the registered user who has reserved the conference, the control unit 10 stores the generated participant information in a portion other than the top portion into the region storing the participant information corresponding to the conference ID.

It is important to be able to identify the registered user for the conference based on the participant information stored in the open state management table 24, but not necessarily to store the participant information of the registered user in the top portion of the region storing participant information corresponding to the conference ID. Thus, it may be configured to prepare registered user flags for the open state management table 24, to set a registered user flag of the registered user as “1” and to set registered user flag of other participants as “0”, in order to identify the registered user.

It is possible to determine whether or not the user authenticated to be the proper participant is the registered user, through considering whether or not the registered user ID included in the reservation information corresponding to the conference ID received from the terminal apparatus 4 is the user ID identifying the user who is authenticated to be the proper participant. In the case that the conference ID received from the terminal apparatus 4 has been already stored in the open state table 24, the control unit 10 stores the generated participant information into a storage portion corresponding to the already stored conference ID.

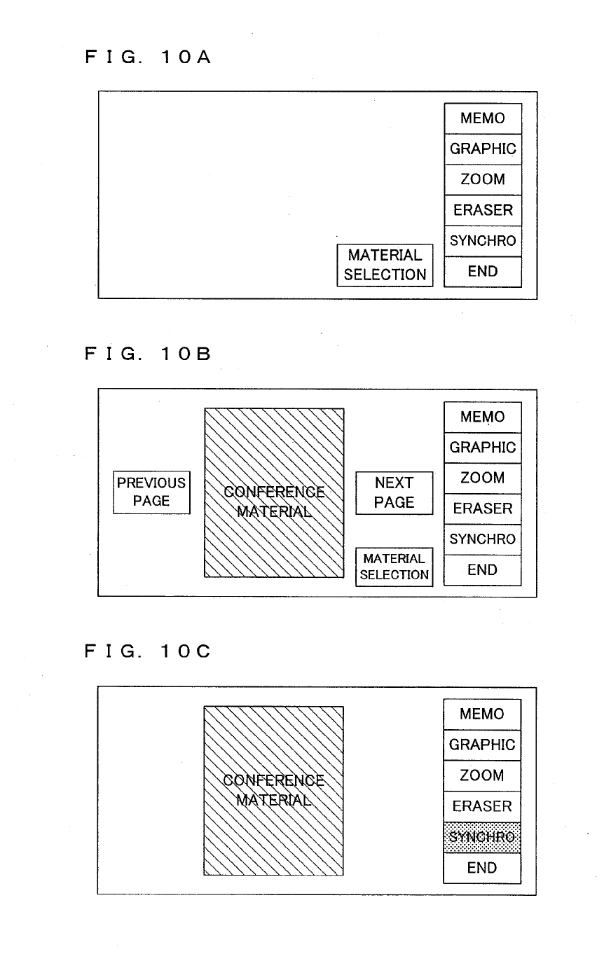

After storing participant information (registered user information) in the open state management table 24, the control unit 10 of the conference server 1 transmits start screen information to the terminal apparatus 4 from which the participation request for the conference has been transmitted (S11). When having received the start screen information for the conference from the conference server 1, the control unit 40 of the terminal apparatus 4 causes the display 33 to show a conference start screen as shown in FIG. 10A (S12). FIG. 10A, FIG. 10B, FIG. 10C are schematic views showing examples of screens displayed by the terminal apparatuses 4, 4, . . . . The conference start screen is for a registered user or a participant (both may be called as participant, hereinafter) to select a conference material to be browsed by the terminal apparatuses 4, 4, . . . . For example, the start screen shown in FIG. 10A illustrates a conference material selecting button.

When a user (participant) of a terminal apparatus 4 clicks the conference material selection button through the manipulating unit 34, the control unit 40 obtains conference material data information (e.g., file name) from the conference server 1 as the conference material data information which is stored in the storage unit 20 of the conference server 1 and is published through the IP network 100a. The control unit 40 can show a list of the obtained conference material data information (not shown), and then the participant of the terminal apparatus 4 can select one information among the list. Therefore, it is possible to request arbitrary conference material data to the conference server 1.

In the start screen shown in FIG. 10A, operating buttons are illustrated in addition to the conference material selecting button. The operating buttons are for a user of a terminal apparatus 4 to perform various processings on the selected conference material through the manipulating unit 34. For example, there are a memo button for adding a memo to the selected conference material, a graphic button for drawing pre-registered graphics, and a zoom button for enlarging or reducing the selected conference material size on the screen, as the operating buttons. In addition, there are an eraser button for erasing added memo or drawn graphics, a synchronizing button, and an end button for requesting to end the teleconference, as the operation buttons. While buttons are shown on various display screens including the conference start screen, such the buttons are not limited to the buttons described above.

When the memo button is clicked, the control unit 40 of the terminal apparatus 4 receives a handwriting input, an insertion of text box, an edit and the like from a user through the manipulating unit 34, and displays the received various information on the display 33. When the graphic button is clicked, the control unit 40 of the terminal apparatus 4 receives a graphic drawing from the user through the manipulating unit 34 and displays the received information on the display 33. When the zoom button is clicked, the control unit 40 of the terminal apparatus 4 enlarges or reduces the displayed conference material at an arbitrary zoom rate on the display 33. Alternatively, it may be configured to display an input field for inputting such the zoom rate in order to receive the zoom rate through the input field, when the zoom button is clicked.

When the eraser button is clicked, the control unit 40 of the terminal apparatus 4 receives an instruction for erasing a memo or a graphic from the user through the manipulating unit 34, and erases the memo or the graphic based on the instruction from the screen on the display 33. When the end button is clicked, the control unit 40 of the terminal apparatus 4 ends the teleconference and reports the end of the teleconference to the conference server 1.

In the conference system 100 according to the Embodiment 1, respective terminal apparatuses 4, 4, . . . are configured to be able to obtain arbitrary conference material data from the conference server 1 and to be able to browse the corresponding conference material. In addition, the chairman or a presenter at the conference is configured to be able to become the registered user who reserves the conference, and terminal apparatuses 4, 4, . . . of respective participants can browse the conference material the same as the conference material currently browsed by the terminal apparatus 4 of the registered user. Thus, when the synchronizing button is clicked, the control unit 40 of the terminal apparatus 4 requests to the conference server 1 for providing with the same conference material data utilized by the terminal apparatus 4 of the registered user. In other words, the conference server 1 transmits the same conference material data both to the terminal apparatus 4, 4, . . . of respective participants having taken the synchronization setting and to the terminal apparatus 4 of the registered user at the synchronized same timing, as the transmitted conference material data is appropriately changed by the request of the registered user.

When the synchronizing button is clicked in a condition having no synchronization setting, the synchronization setting is applied. On the other hand, when the synchronizing button is clicked in a condition having the applied synchronization setting, the applied synchronization setting is canceled. In addition, the other buttons are also configured similarly to the synchronizing button. For example, when the memo button is clicked in not-memo input mode, the memo input mode is applied for inputting a memo. On the other hand, when the memo button is clicked in the applied memo input mode, the applied memo input mode is canceled.

In the case of displaying the screen shown in FIG. 10A on the display 33, the control unit 40 of the terminal apparatus 4 considers whether or not arbitrary conference material data is selected through the conference material selecting button with utilizing the manipulating unit 34 by a participant, and then determines whether or not having received the selection of the conference material data, in accordance with the consideration (S13). When having determined to receive the selection of the conference material data (S13: YES), the control unit 40 requests to the conference server 1 through the communicating unit 44 for providing the conference material data selected by the participant (S14).

When having determined not to receive the selection of the conference material data (S13: NO), the control unit 40 determines whether or not the synchronizing button has been clicked on the screen shown in FIG. 10A (S15). When having determined that the synchronizing button is not clicked (S15: NO), the control unit 40 moves the procedure to the step S16. When having determined that the synchronizing button is clicked (S15: YES), the control unit 40 reports to the conference server 1 that the synchronization setting is selected, and requests to the conference server 1 for providing the same conference material data currently utilized by the terminal apparatus 4 of the registered user (S14).

The control unit 10 of the conference server 1 determines whether or not having received a request of the conference material data from the terminal apparatus 4 through the communicating unit 12 (S19). When having determined not to receive the request (S19: NO), the control unit 10 of the conference server 1 moves the procedure to the step S23. When having determined to receive the request (S19: YES), the control unit 10 stores the requested conference material data (file name and page number) into the open state management table 24 as the browsing information corresponding to the participant ID identifying the participant who has requested the conference material data (S20). Then, the control unit 10 reads out the conference material data from the storage unit 20, which is the browsing information stored in the open state management table 24, and transmits the read conference material data to the terminal apparatus 4 through the communicating unit 12 (S21).

When having received a request from the terminal apparatus 4 for providing the same conference material utilized by the terminal apparatus 4 of the registered user, i.e., when having received a report representing that the synchronization setting is selected, the control unit 10 stores “synchronization” into the open state management table 24 as the browsing information corresponding to the participant ID identifying the participant who has requested the conference material data (S20). Then, the control unit 10 reads out the conference material data from the storage unit 20, which is the same as the conference material data currently browsed by the registered user, in accordance with the browsing information corresponding to the registered user, and transmits the read conference material data to the terminal apparatus 4 (S21).

In the case that the participant requesting the conference material data is the registered user, the control unit 10 transmits the requested conference material data to the terminal apparatuses 4, 4, . . . whose open state management tables 24, 24, . . . stores the “synchronization” as the browsing information, as well as transmits the requested conference material data to the terminal apparatus 4 of the registered user. Therefore, the registered user can obtain arbitrary conference material data, and the terminal apparatuses 4, 4, . . . can also obtain the conference material data currently browsed by the registered user, as well as can obtain arbitrary conference material data from the conference server 1.

The control unit 40 of the terminal apparatus 4 determines through the communicating unit 44 whether or not having received the conference material data from the conference server 1 (S16). When having determined to receive the conference material data (S16: YES), the control unit 40 outputs the received conference material data to the display 33 through the signal processing unit 45 and the display processing unit 48, and causes the display 33 to show the conference material on the display screen as shown in FIG. 10B or FIG. 10C (S17). When having determined not to receive the conference material data (S16: NO), the control unit 40 skips the step S17.

The display screen shown in FIG. 10B is an example of display screen shown on the terminal apparatus 4 of the registered user or shown on the terminal apparatus 4 of the participant who does not apply the synchronization setting for synchronizing with the terminal apparatus 4 of the registered user. On the other hand, the display screen shown in FIG. 10C is an example of display screen shown on the terminal apparatus 4 of the participant who applies the synchronization setting for synchronizing with the terminal apparatus 4 of the registered user.

After receiving the conference material data from the conference server 1 based on the participant's request, the terminal apparatus 4 displays the received conference material data as shown in FIG. 10B, and displays a previous page button and a next page button for changing the displayed page of the conference material. The display screen shown in FIG. 10B, as well as the display screen shown in FIG. 10A, displays the conference material selecting button for newly selecting a conference material to be browsed by the participants with the terminal apparatuses 4, 4, . . . . On the other hand, in the case of having the applied synchronization setting already for synchronizing with the terminal apparatus 4 of the registered user, the terminal apparatus 4 displays only the received conference material data as shown in FIG. 10C. In addition, the display screen shown in FIG. 10C displays the synchronizing button with different color from the other buttons in order to report to the participant that the synchronization setting is applied.

In the case that respective participants want to end the conference with the terminal apparatus 4, 4, . . . displaying the display screens on the display 33 as shown in FIG. 10B or FIG. 10C, the end button should be clicked through the manipulating unit 34. The control unit 40 of the terminal apparatus 4 determines whether the end button is clicked by the participant or not (S18). When having determined that the end button is not clicked (S18: NO), the control unit 40 of the terminal apparatus 4 moves the procedure to the step S13. Then, the control unit 40 repeats steps from the step S13 to the step S18 until the end button is clicked by the participant.

In the case that the end button is clicked in the terminal apparatus 4 displaying the display screen on the display 33 as shown in FIG. 10B, the control unit 40 applies the synchronization setting for synchronizing with the terminal apparatus 4 of the registered user, obtains the same conference material from the conference server 1 which is currently browsed by the registered user, and changes to display the display screen as shown in FIG. 10C. In the case that the end button is further clicked in the terminal apparatus 4 displaying the display screen on the display 33 as shown in FIG. 10C, the control unit 40 cancels the applied synchronization setting for synchronizing with the terminal apparatus 4 of the registered user, and changes to display the display screen as shown in FIG. 10B in order to obtain arbitrary conference materials from the conference server 1.

When having determined that the end button is clicked on the display screen as shown in FIG. 10B or FIG. 10C (S18: YES), the control unit 40 ends the teleconference. Then, the control unit 40 transmits the terminal ID of own terminal apparatus 4 or the participant ID of the participant through the communicating unit 44 to the conference server 1, and transmits the conference ending request (S22). The control unit 10 of the conference server 1 determines whether having received the conference ending request through the communicating unit 12 from the terminal apparatus 4 or not (S23). When having determined not to receive the conference ending request (S23: NO), the control unit 10 moves the procedure to the step S19.

When having determined to receive the conference ending request (S23: YES), the control unit 10 determines whether the participant requesting to end the conference is the registered user or not (S24). Specifically, the control unit 10 considers whether or not the participant information including the terminal ID of the terminal apparatus 4 requesting to end the conference or including the participant ID of the participant requesting to end the conference is stored in the top portion of the region storing participant information of the open state management table 24, and then determines whether the requesting user is the registered user or not, in accordance with the consideration. In the case that the reservation information is configured not to be deleted from the reservation state management table 22 even after the corresponding conference is opened, the control unit 10 may determine in accordance with the reservation information whether the requesting user is the registered user or not.

When having determined that the requesting user is not the registered user (S24: NO), the control unit 10 ends the conference only with the participant who has requested to end the conference (S25). Specifically, the control unit 10 deletes only the participant information for the participant from the open to state management table 24 who has requested to end the conference. The control unit 10 of the conference server 1 may re-transmit a web page for receiving a conference participation request to the terminal apparatus 4 of the participant who ends the participation in the conference. The control unit 10 of the conference server 1 moves the procedure to the step S19. Then, when having received a request for providing conference material data from another participant, the control unit 10 appropriately transmits the conference material data based on the request to the corresponding terminal apparatuses 4, 4, . . . .

When having determined that the requesting user is the registered user (S24: YES), the control unit 10 ends the conference with all the participants (S26) and completes the procedure described above. Specifically, the control unit 10 deletes all the participant information from the open state management table 24 which is corresponding to the conference ID of the conference requested to be ended by the registered user. The control unit 10 may transmit screens for reporting the end of conference or web pages for receiving conference participation requests, to the terminal apparatuses 4, 4, . . . of the participants whose participant information is deleted from the open state management table 24. Thus, the participants of the terminal apparatuses 4, 4, . . . can comprehend the fact that the conference is ended.

The conference server 1 is illustrated above to appropriately transmit the conference material data to the terminal apparatuses 4, 4, . . . which correspond to the requests from the terminal apparatuses 4, 4, . . . . Furthermore, while transmitting the conference material data to the terminal apparatuses 4, 4, . . . , the conference server according to the Embodiment 1 can keep sound signals generated from sounds collected by the microphones 31, 31, . . . of the terminal apparatuses 4, 4, . . . and can transmit the sound signals to the terminal apparatuses 4, 4, . . . , respectively. Therefore, even in the case that the conference system 100 is utilized for teleconference, it is possible to transmit/receive speeches of respective participants among the terminal apparatuses 4, 4, . . . . In addition, the conference server 1 according to the Embodiment 1 may be configured to select the sound signal having the largest sound volume, when transmitting the sound singles to the terminal apparatuses 4, 4, . . . . The conference server 1 according to the Embodiment 1 may be configured to collect sounds by the microphone 31 of a previously registered terminal apparatus 4 (for example, the terminal apparatus 4 of the registered user) and to transmit the sound signals generated from the collected sounds to the other terminal apparatuses 4, 4, . . . .

The conference server 1 of the embodiment 1 relays the teleconference performed among plural terminal apparatuses 4, 4, . . . as described above, and further decides in accordance with the information transmitted/received among the terminal apparatuses 4, 4, . . . whether the discussion matches to the subject or not. In the Embodiment 1, it is configured to utilize keywords previously registered on the keyword DB 27 by the registered user of the conference, for deciding whether the discussion matches to or is strayed from the subject.

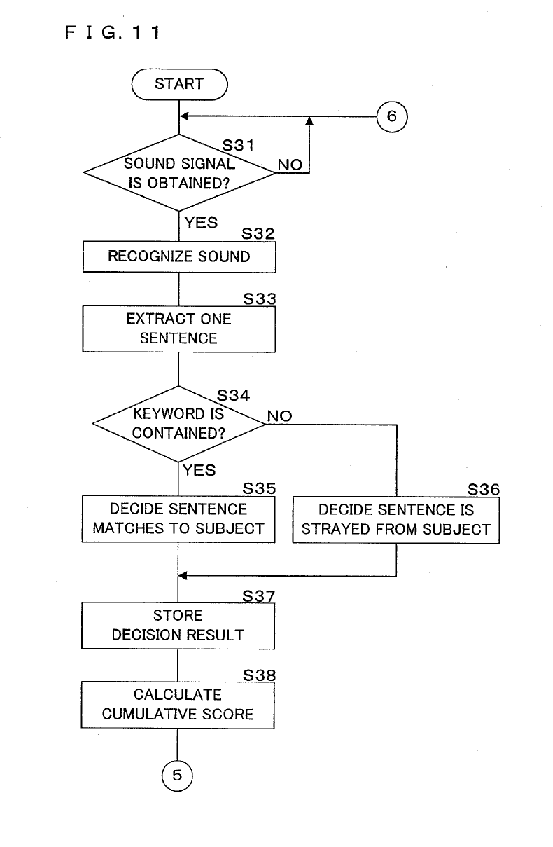

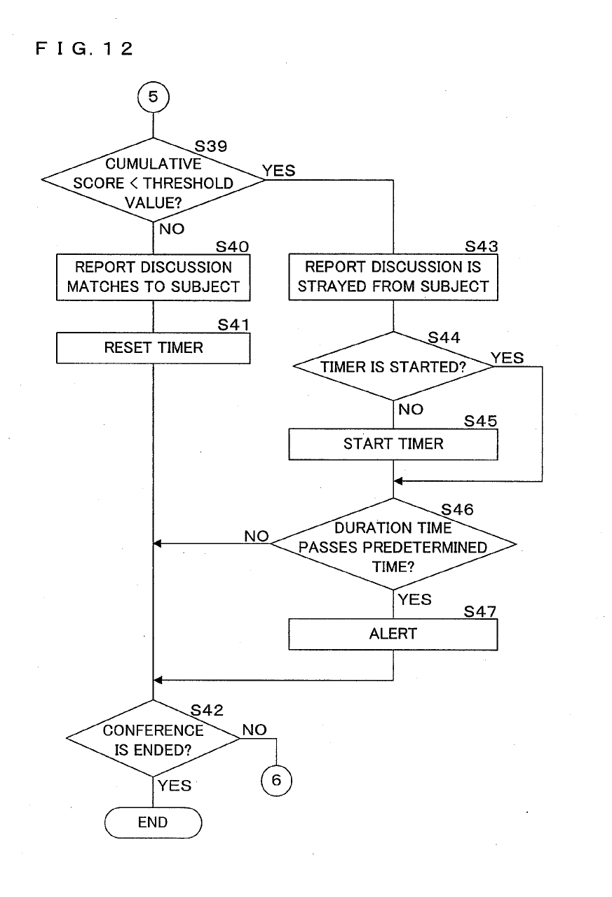

It will be described below about discussion decision processing performed by the conference server 1. FIG. 11 and FIG. 12 are flowcharts showing a procedure of discussion decision processing performed by the conference server 1. The control unit 10 of the conference server 1 performs the following procedure.

While relaying the teleconference as shown in FIG. 7, FIG. 8 and FIG. 9, the control unit 10 of the conference server 1 determines whether or not having obtained sound signals being output from the terminal apparatuses 4, 4, . . . at some teleconference (S31). The control unit 40 of each of terminal apparatuses 4, 4, . . . transmits the sound signals collected by the microphone 31 to the conference server 1 from time to time. When having determined not to obtain the sound signals (S31: NO), the control unit 10 of the conference server 1 waits while performing processing shown in FIG. 7, FIG. 8 and FIG. 9.

When having determined to obtain the sound signals (S31: YES), the control unit 10 performs sound recognition processing on the obtained sound signals based on the sound recognition DB 25 (S32), and then converts the sound signals into text information. The control unit 10 performs language analysis processing on the generated text information based on the language analysis DB 26, and then extracts one sentence (S33). The control unit 10 reads out keywords from the keyword DB 27 which correspond to the teleconference, compares each word contained in the extracted one sentence and the read keywords, and then decides whether this sentence contains any keyword or not (S34).

When having decided that this sentence contains any keyword (S34: YES), the control unit 10 decides that this sentence matches to the subject to be discussed (S35). On the other hand, when having decided that this sentence contains no keyword (S34: NO), the control unit 10 decides that this sentence is strayed from the subject to be discussed (S36). In addition, the control unit 10 has a clock function for clocking time course since respective conferences are opened. When having obtained the decision result, the control unit 10 stores the decision result into the decision result DB 28 in association with the conference ID and with the time course since the conference is opened (S37).

The control unit 10 calculates the cumulative score based on the decision results (S38). Specifically, when having decided that this sentence matches to the subject to be discussed, the control unit 10 adds a predetermined score (e.g., “1”) to the cumulative score stored in the decision result DB 28 in association with the conference ID. On the other hand, when having decided that this sentence is strayed from the subject to be discussed, the control unit 10 subtracts a predetermined score (e.g., “1”) from the cumulative score stored in the decision result DB 28 in association with the conference ID.

The control unit 10 determines whether the calculated cumulative score is less than a predetermined threshold value or not (S39). When having determined that the cumulative score is not less than the threshold value (S39: NO), the control unit 10 decides that the current discussion matches to the subject. Then, the control unit 10 transmits a message, e.g., “discussion matches to subject” through the communicating unit 12 to respective terminal apparatuses 4, 4, . . . participating in the conference, and reports the fact that the current discussion matches to the subject (S40). After receiving such the message, each control unit 40 of the terminal apparatuses 4, 4, . . . outputs the received message to the display 33 through the signal processing unit 45 and the display processing unit 48, and displays the message on a predetermined display region in the display screen. Therefore, the conference server 1 can report to each participant that the discussion at the conference matches to contents based on the keywords stored in the keyword DB 27.

The control unit 10 has a timer for measuring duration time of a state decided to be strayed from the subject. When having decided that the discussion matches to the subject, the control unit 10 resets this timer (S41), and stops the reset timer. In addition, the control unit 10 determines whether the teleconference is ended among the terminal apparatuses 4, 4, . . . or not (S42). When having determined that the teleconference is not ended (S42: NO), the control unit 10 returns the procedure to the step S31 and repeats the processes described above. On the other hand, when having determined that the teleconference is ended (S42: YES), the control unit 10 completes the decision processing described above. Furthermore, the control unit 10 ends the teleconference in response to receiving the conference end request from the terminal apparatus 4 when the registered user of the conference clicks the end button with utilizing the terminal apparatus 4.

When having determined that the calculated cumulative score is less than the threshold value (S39: YES), the control unit 10 decides that the current discussion is strayed from the subject. Then, the control unit 10 transmits a message, e.g., “discussion is strayed from subject” through the communicating unit 12 to respective terminal apparatuses 4, 4, . . . participating in the conference, and reports the fact that the current discussion is strayed from the subject (S43). After receiving such the message, each control unit 40 of the terminal apparatuses 4, 4, . . . outputs the received message to the display 33 through the signal processing unit 45 and the display processing unit 48, and displays the message on a predetermined display region in the display screen. Therefore, the conference server 1 can report to each participant that the discussion at the conference is strayed from contents based on the keywords stored in the keyword DB 27.

The Embodiment 1 is illustrated above to display the message on each display 33 of the terminal apparatuses 4, 4, . . . for reporting to each participant. Alternatively, it may be configured to utilize two different colors (for normal condition and for abnormal condition) as the color of display screen on the display 33, or utilize the color of window dedicated for the teleconference on the display 33, and to change the displayed color based on the decision result whether the discussion matches to or is strayed from the subject, for reporting the decision result. Alternatively, it may be configured to utilize a different window shape dedicated to the teleconference on the display 33 from the normal condition for reporting the decision result. Such the window shape may be pre-set on the display 33.

The control unit 10 determines whether or not the timer starts measuring duration time decided to be strayed from the subject (S44). When having determined that the timer does not start (S44: NO), the control unit 10 causes the timer to start measuring (S45). When having determined that the timer already starts (S44: YES), the control unit 10 skips the step S45.

The control unit 10 determines in accordance with the duration time measured by the timer whether or not it passes a predetermined time with the condition continuously decided to be strayed from the subject (S46). When having determined that it does not pass the predetermined time (S46: NO), the control unit 10 moves the procedure to the step S42, and determines whether or not the teleconference is ended among the terminal apparatuses 4, 4, . . . (S42). When having determined that it passes the predetermined time (S46: YES), the control unit 10 transmits a message, such as “discussion is strayed from subject for long period” or “return discussion to subject”, through the communicating unit 12 to respective terminal apparatuses 4, 4, . . . participating in the conference, in order to alert the participants (S47). Then, the control unit 10 moves the procedure to the step S42 and determined whether the teleconference is ended among the terminal apparatuses 4, 4, . . . or not (S42).

Therefore, the conference server 1 can alert respective participants that the discussion is significantly strayed from the subject, in the case that it passes the predetermined time with the discussion at the conference being continuously strayed from the contents based on the keywords stored in the keyword DB 27. Alternatively, it may be configured to report a message for urging the registered user or respective participants to take a rest, instead of alert. As described above, the conference server 1 can alert respective participants when the discussion is strayed from the subject during not less than the predetermined time (e.g., 10 minutes). Therefore, it is possible to smoothly proceed the conference.

In the conference system 100 according to the Embodiment 1 as described above, it is possible not only to perform the teleconference among plural terminal apparatuses 4, 4, . . . , but also to decide whether or not the discussion at the teleconference matches to the contents based on the keywords previously registered on the keyword DB 27. Therefore, it is possible to consider discussed contents themselves and to comprehend the state of the discussion based on the consideration, e.g., whether the participants are active for the discussion or not, whether the discussion matches to the subject or not, whether the discussion is strayed from the subject or not, and the like. Furthermore, the conference server 1 according to the Embodiment 1 utilizes the cumulative score for deciding whether the discussion matches to the subject or not. Therefore, it is possible to facilitate comprehending whole of the discussion for such the decision.

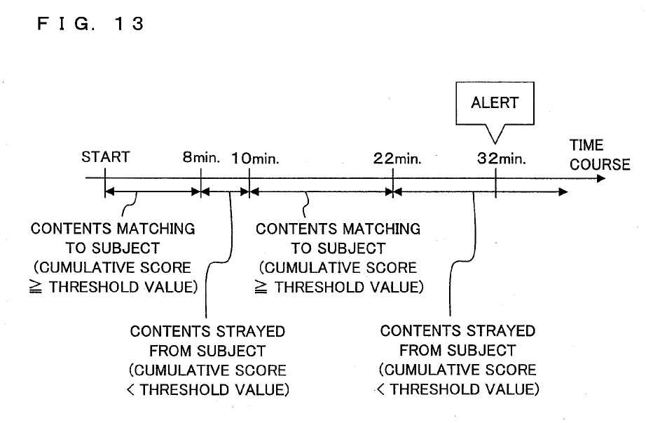

The conference server 1 according to the Embodiment 1 stores decision results in association with the time course since the conference is opened, as each of the decision results represents whether a speech of a participant matches to the subject or not. Therefore, it is possible to comprehend the conference, such as the time when the discussion began to be strayed from the subject, after the conference is closed. The conference server 1 may display the decision results stored in the decision result DB 28 as shown in FIG. 13. FIG. 13 is a schematic view showing an example of decision results. The horizontal axis in FIG. 13 represents time course since the conference is opened, and FIG. 13 illustrates decision results at respective time points whether the discussion matches to or is strayed from the subject.

In the Embodiment 1, it is possible to easily comprehend the state of the conference at each time point, since such the display screen can be displayed on the display 33 of the terminal apparatus 4 or on the display connected to the conference server 1. In the case that the alerted timing is displayed as shown in FIG. 13, it is possible to facilitate comprehending the time when the participants are alerted. Although the storing method is illustrated above for storing the decision results in the decision result DB 28, the storing method is not limited to the configuration illustrated above. For example, it may be configured to store cumulative scores at respective time points in association with time course since the conference is opened. In addition, it may be configured to store cumulative score per predetermined interval.

The conference server 1 according to the Embodiment 1 is illustrated to transmit the decision result message or the alert message to the terminal apparatuses 4, 4, . . . through the IP network 100a, for reporting respective participants. Alternatively, it may be configured to connect a big display with the conference server 1 and to display the message on the big display, for reporting respective participants. In the case that participants stay in the same room, the alternative configuration can report the message to respective participants without interfering in the conference material display on the display 33 of respective terminal apparatuses 4, 4, . . . .

The conference server 1 according to the Embodiment 1 is illustrated above to consider whether or not speech contents of respective participants contain keywords stored in the keyword DB 27, and to decide in accordance with the consideration whether the discussion matches to the subject or not. Furthermore, the conference server 1 may have a prepared synonym dictionary about synonyms having nearly the same meaning as the keywords (words), consider whether or not speech contents of respective participants contain keywords or synonym of the keywords, and to decide in accordance with the consideration whether the discussion matches to the subject or not. The registered user of the conference may register not only the keywords but also the synonyms of the keywords. The cumulative score may be calculated to be different scores between the case that a keyword is contained in a speech content of each participant and the case that a synonym is contained in the speech content of each participant.

The conference server 1 according to the Embodiment 1 is illustrated above to perform decision processing with keywords only pre-stored in the keyword DB 27. Alternatively, it may be configured that a new keyword can be added appropriately, for example, by the chairman (registered user) of the conference inputting the new keyword through the manipulating unit 34 of the terminal apparatus 4 during the conference. Therefore, it is possible to register a keyword matching to the agenda and to comprehend the state of the conference accurately, even in the case that the agenda of the conference is changing in real time.

### Embodiment 2

It will be described below about the conference system according to an Embodiment 2 provided with a conference relay apparatus according to the present invention. The conference server 1 and the terminal apparatus 4, 4, . . . according to the Embodiment 2 are implemented with configurations the same as the conference server 1 and the terminal apparatuses 4, 4, . . . according to the Embodiment 1. The conference server 1 according to the Embodiment 2 performs processing the same as the conference server 1 according to the Embodiment 1 described above. In addition, the conference server 1 according to the Embodiment 2 extracts a keyword from speech contents of respective participants based on the sound signals transmitted/received among the terminal apparatuses 4, 4, . . . .

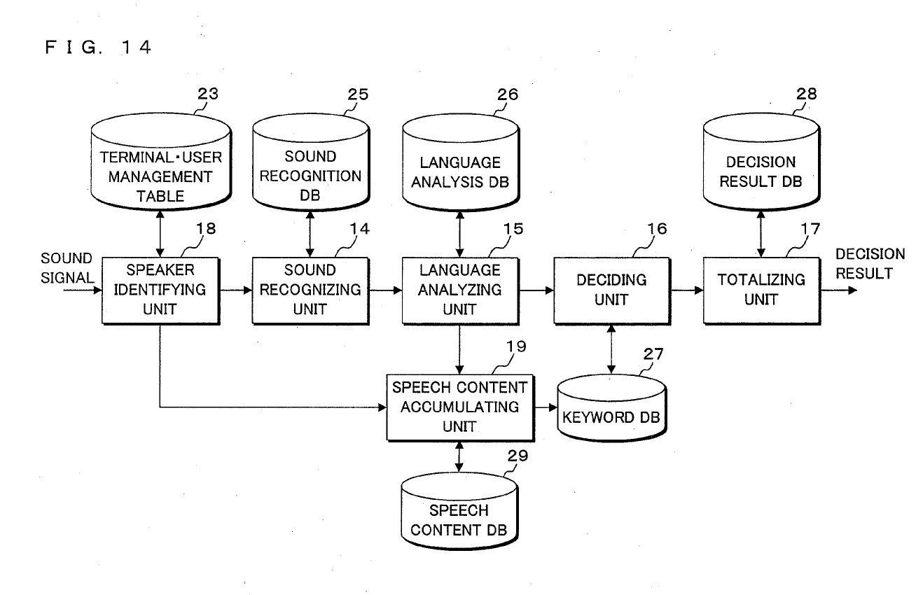

FIG. 14 is a block diagram showing a functional configuration of the conference server according to the Embodiment 2. In the conference serve 1 according to the Embodiment 2, the control unit 10 executes the control program stored in the storage unit 20 to implement not only the functions shown in FIG. 6 but also a speaker identifying unit 18 and a speech content accumulating unit 19.

The control unit 40 of respective terminal apparatuses 4, 4, . . . transmits a terminal ID of own terminal apparatus 4 or a participant ID of the participant, in addition to the various signals, to the conference server 1. When having received the sound signals through the communicating unit 12, the speaker identifying unit 18 identifies a participant (speaker) based on the terminal ID or the participant ID of the terminal apparatus 4 who has given a speech for the received sound signals. For example, when having received the terminal ID together with the sound signals, the speaker identifying unit 18 refers the terminal-user management table 23 and then identifies the participant ID (user ID) corresponding to the received terminal ID. For example, when having received the participant ID together with the sound signals, the speaker identifying unit 18 can directly identify the participant of the participant ID as the speaker.

The speaker identifying unit 18 outputs the participant ID of the participant identified as the speaker to the speech content accumulating unit 19. In addition, the speaker identifying unit 18 outputs the sound signals received through the communicating unit 12 directly to the sound recognizing unit 14.

The language analyzing unit 15 according to the Embodiment 2 outputs words per sentence to the deciding unit 16 and the speech content accumulating unit 19, as the words are obtained by the language analysis processing performed on the text information. Alternatively, the language analyzing unit 15 may output words contained in the speech contents of each speaker, as the output words are per speaker identified by the speaker identifying unit 18 but not per sentence.

The speech content accumulating unit 19 obtains the participant ID of the speaker from the speaker identifying unit 18, and then obtains respective words from the language analyzing unit 15 which are contained in the speech contents of respective speaker. The speech content accumulating unit (extracting unit) 19 extracts words utilized as the keyword for comprehending the state of the discussion, such as noun or proper noun, from the respective words obtained from the language analyzing unit 15, and accumulates the extracted words in the speech content DB 29.

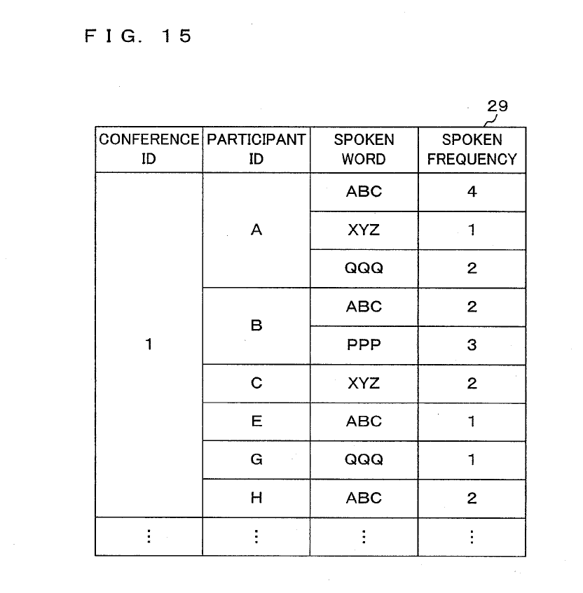

FIG. 15 is a schematic view showing data contents of a speech content DB 29. As shown in FIG. 15, the speech content DB 29 stores the spoken words extracted from the speech contents of respective participants and the occurrence frequencies (spoken frequencies) for respective words, in association with the conference ID of the conference and the participant ID of the participant of the conference. The data contents of the speech content DB 29 are stored by the control unit 10 (speech content accumulating unit 19), every time when the control unit 10 (speech content accumulating unit 19) of the conference server 1 extracts a word utilized as the keyword from the sound signals received from the terminal apparatuses 4, 4, . . . .

Therefore, the speech content accumulating unit (occurrence frequency counting unit) 19 accumulates the respective extracted words in the speech content DB 29 in association with the conference ID and the participant ID, and sequentially updates the occurrence frequencies (spoken frequencies) for respective words. It is preferred for the speech content accumulating unit 19 to accumulate words in the speech content DB 29 in which improper words for comprehending the state of the discussion, such as “I” and “Mr./Ms. . . . ”, are excluded. Such the improper words to be excluded may be previously stored in the storage unit 20.

After accumulating a word spoken by a participant in the speech content DB 29, the speech content accumulating unit 19 determines whether or not the currently accumulated word should be registered on the keyword DB 27 as a new keyword. Specifically, after accumulating a word spoken by a participant in the speech content DB 29, the speech content accumulating unit (registering unit) 19 determines whether or not the currently accumulated word meets a predetermined condition, and registers the currently accumulated word on the keyword DB 27 as a keyword of the corresponding conference in the case that the currently accumulated word meets the predetermined condition. For example, the predetermined condition is that the number of participants who have spoken the word is not less than a predetermined number, that the total spoken frequency number is not less than a predetermined number, that not less than a predetermined frequency number of the word are spoken by not less than predetermined number of participants, or the like. Furthermore, the determination processing may be performed in accordance with a condition which combines such the conditions described above.

In the case that it is configured to register the word on the word DB 27 which is spoken by not less than predetermine number of participants as described above, the registered word can be utilized as the keyword in the later decision processing. Therefore, it is possible to determine whether the discussion matches to the contents represented by the contained keyword or not, in accordance with not only the keywords that are previously stored but also the keywords that match to the discussion contents in real time.

It will be described below about processing performed by the conference server 1 and the terminal apparatuses 4, 4, . . . in the conference system 100 according to the Embodiment 2. It should be noted that the conference system 100 according to the Embodiment 2 brings processing performed by the conference server 1 and the terminal apparatus 4 for a user reserving a conference with manipulating the terminal apparatus 4, and processing performed by the conference server 1 and the terminal apparatus 4 for the reserved user (registered user) registering a keyword of the conference with manipulating the terminal apparatus 4, as both processings are the same between in the Embodiment) and in the Embodiment 2.

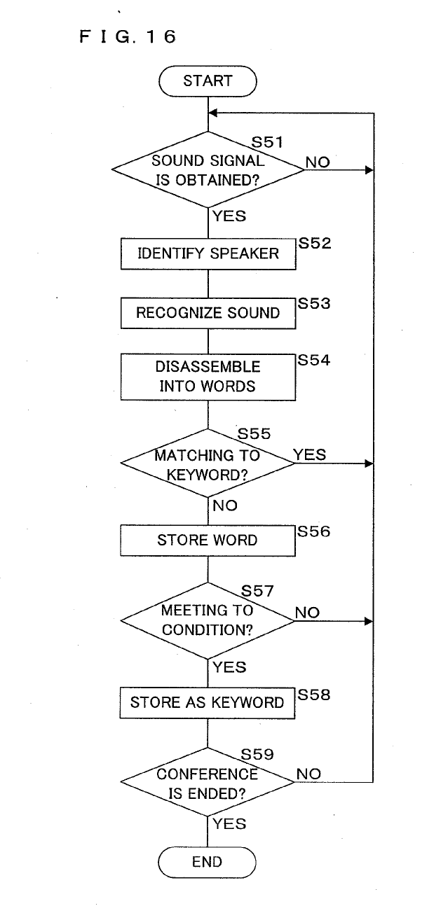

Next, it will be described about processing for registering keywords based on speech contents of participants at the conference, which is a significant function of the conference server 1 according to the Embodiment 2. FIG. 16 is a flowchart showing a procedure of keyword registration processing performed by the conference server 1. The processing described below is performed by the control unit 10 of the conference server 1. The control unit 10 of the conference server 1 performs the keyword registration processing based on the speech contents of respective participants, while performing the teleconference relay processing as shown in FIG. 7, FIG. 8 and FIG. 9 and the discussion decision processing as shown in FIG. 11 and FIG. 12.

The control unit 10 of the conference server 1 determines whether or not having obtained sound signals being output from the terminal apparatuses 4, 4, . . . at a teleconference (S51). When having determined not to obtain the sound signals (S51: NO), the control unit 10 waits while performing another processing. When having determined to obtain the sound signals (S51: YES), the control unit 10 identifies the user (speaker) of the terminal apparatus 4 from which the sound signals have been transmitted (S52). Specifically, the control unit 10 identifies the participant (speaker) who has spoken words generating these sound signals, in accordance with the terminal ID or the participant ID of the terminal apparatus 4 received together with these sound signals.

The control unit 10 performs sound recognition processing on the obtained sound signals based on the sound recognition DB 25 (S53), and converts the obtained sound signals into the text information. The control unit 10 performs language analysis processing on the generated text information based on the language analysis DB 26, and disassembles the generated text information into words (S54). Then, the control unit 10 determines whether or not each of the disassembled words matches to any keyword stored in the keyword DB 27 or not (S55). At that time, the control unit 10 excludes improper words for comprehending the state of the discussion, such as “I” and “Mr./Ms. . . . ” from the disassembled words, and then determines whether each word matches to any keyword or not.

When having determined to match to any keyword (S55: YES), the control unit 10 returns the procedure to the step S51 without performing the keyword registration processing because the matched word has been stored in the keyword DB 27 already. When having determined not to match to any keyword (S55: NO), the control unit 10 stores the not-matched word in the speech content DB 29 in association with the conference ID and with the participant ID of the speaker identified at the step S52 because the not-matched word has not been stored in the keyword DB 27 yet (S56).

The control unit 10 determines whether the stored word in the speech content DB 29 meets a predetermined condition or not (S57). When having determined not to meet the predetermined condition (S57: NO), the control unit 10 returns the procedure to the step 551. For each conference, the control unit 10 reads out the number of speakers who have spoken each word stored in the speech content DB 29, speech frequencies of each word stored in the speech content DB 29, and the like, and then determines whether the predetermined condition is met or not.

When having determined to meet the predetermined condition (S57: YES), the control unit 10 stores the met word as a keyword into the keyword DB 27 (S58). At that time, the control unit 10 may delete the met word and the spoken frequencies of the met word from the speech content DB 29. Then, the control unit 10 determines whether or not the teleconference has been ended among the terminal apparatuses 4, 4, . . . (S59). When having determined that the teleconference is not ended yet (S59: NO), the control unit 10 returns the procedure to the step S51 and repeats the processes described above. When having determined that the teleconference is ended already (S59: YES), the control unit 10 completes the registration processing described above.

In the conference system 100 according to the Embodiment 2 described above, it is configured to newly register the keyword utilized for comprehending the state of the discussion, in accordance with the sound signals received from the terminal apparatuses 4, 4, . . . , i.e., in accordance with the speech contents of participants at the conference. Therefore, it is possible to comprehend the state of the discussion, in accordance with not only the keyword that has been registered previously but also the keyword based on the speech contents of the participants during the proceeding discussion.

The conference server 1 according to the Embodiment 2 is illustrated above to register a word spoken by plural participants, a word spoken plural times by respective participants, and the like on the keyword DB 27 as the keyword, in accordance with the speech contents of participants at the conference. Alternatively, it may be configured to register keywords based on speech contents of the participants during a predetermined time span (e.g., 10 minutes) since the conference is opened. At the initial time immediately after the conference is opened, the participants tend to perform the discussion according to the initial agenda. Thus, in the case that the keywords are selected in accordance with the speech contents of the participants discussing at the initial time, it is possible to register keywords that are not strayed from the initial agenda. At the later time passing some time after the conference is opened, the participants may perform discussion that is strayed from the initial agenda. Thus, in the case that the keywords are selected in accordance with the speech contents of the participants discussing at the later time, it is highly expected that the selected keywords are strayed away from the initial agenda.

Some conferences are expected to change the agenda in real time. In view of such the conferences, the Embodiment 2 is illustrated to sequentially change the keywords based on the speech contents of the participants until the conference is closed. Thus, it is possible to register the keywords that match to the agenda changing in real time. Therefore, it is possible in accordance with such the registered keywords to accurately decide whether the discussion matches to the subject or not, even for the conference whose discussions are changed in real time.

In the case that a participant speaks “AAA is important”, “it should be considered about AAA”, “do not forget AAA” or the like, i.e., the case that the speech contents contains the word “AAA” expected to be important at the conference, it may be configured to register such the word “AAA” as the keyword on the keyword DB 27. For example, when a participant speaks “The CO₂ reduction is important for the countermeasures against global warming”, the conference server 1 extracts the word “important” from this speech content and registers a word “CO₂ reduction” as the keyword which corresponds to the extracted word “important”.

### Embodiment 3

It will be described below about the conference system according to an Embodiment 3 provided with the conference relay apparatus according to the present invention. The conference server 1 and the terminal apparatuses 4, 4, . . . according to the Embodiment 3 can be implemented by the same configurations as the conference server 1 and the terminal apparatuses 4, 4, . . . according to the Embodiment 1. The conference server 1 according to the Embodiment 3 performs processing the same as the conference server 1 according to the Embodiment 1 described above. Furthermore, the conference server 1 according to the Embodiment 3 extracts keywords from the conference material data which should be stored in the keyword DB 27, and registers the extracted keywords on the keyword DB 27.

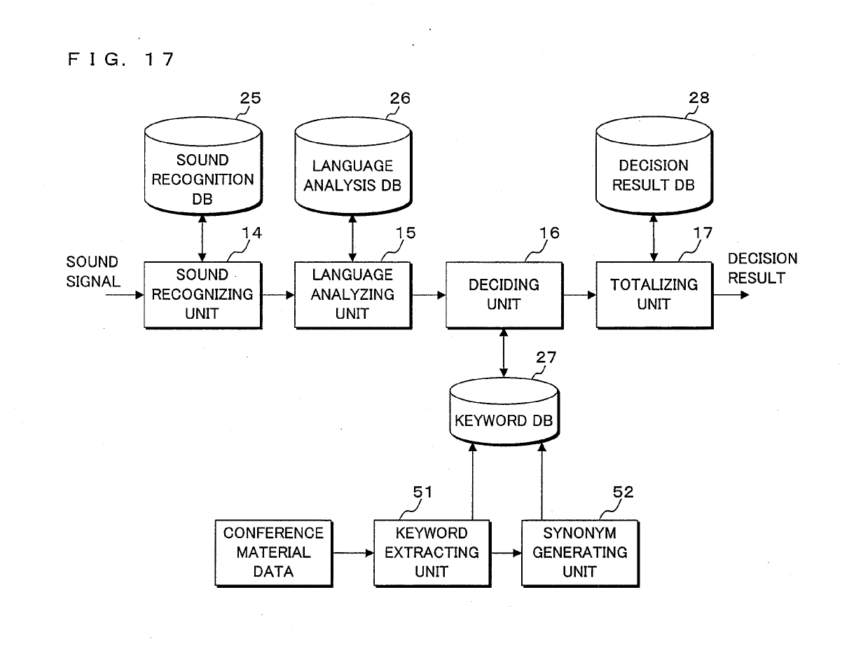

FIG. 17 is a block diagram showing a functional configuration of the conference server 1 according to the Embodiment 3. In the conference server 1 according to the Embodiment 3, the control unit 10 executes the control program stored in the storage unit 20 to implement not only the functions shown in FIG. 6 but also a keyword extracting unit 51 and a synonym generating unit 52.

In the conference system 100 according to the Embodiment 3, it is configured to register material information for identifying each material utilized at a conference, as well as the register ID of the registered user, the opening date of the conference and the participant IDs of the participants, when a user (registered user) tries to reserve the conference. Thus, the material information is also contained in the reservation information stored in the reservation state management table 22 in the Embodiment 3. For example, it is possible to utilize a file name of the conference material data as the material information. The material information is for identifying the conference material data having been stored in the storage unit 20 of the conference server 1. When trying to reserve the conference, the registered user of the conference registers (stores on the storage unit 20 of the conference server 1) the conference material data, too.

In the case that the conference material data is a document, such as text data, generated with a personal computer, a workstation or the like, the registered user transmits the conference material data to the conference server 1 through the terminal apparatus 4 to store the conference material data in the storage unit 20. In the case that the conference material is a paper medium, the registered user reads the conference material with a scanner connected to the terminal apparatus 4 or to the conference server 1, and stores the obtained image data from the read conference material into the storage unit 20 of the conference server 1.

The keyword extracting unit 51 performs processing, for example, similar to the language analysis processing performed by the language analyzing unit 15 onto the conference material data registered as the conference material after the reservation of the conference, to break down into words. In the case that the conference material data is generated from the paper medium being read by the scanner (i.e., image data), the keyword extracting unit 51 converts the image data into the text data with an optical character reader (OCR) for extracting characters in an image, and then disassembles into words with the language analysis processing. In the case that the scanner has the OCR function, it may be configured to register the text data converted from the image data by the OCR function onto the conference server 1, together with the image data obtained by the scanner.

The keyword extracting unit 51 counts the occurrence frequency of each disassembled word. Although counting the occurrence frequency of each word, the keyword extracting unit 51 excludes the improper words that cannot be utilized as the keywords for comprehending the state of the discussion, such as “I” and “Mr./Ms. . . . ”. After counting the occurrence frequency of each disassembled word, the keyword extracting unit 51 determines whether or not the occurrence frequency of each disassembled word is not less than a predetermined time (e.g., 10 times), and stores the word as the keyword into the keyword DB 27 whose occurrence frequency is not less than the predetermined time. The keyword extracting unit 51 associates such the word, having the occurrence frequency not less than the predetermined time and stored in the keyword DB 27, with the conference ID of the conference. In addition, the keyword extracting unit 51 outputs the word stored in the keyword DB 27 as the keyword to the synonym generating unit 52.

The synonym generating unit 52 generates a synonym having nearly the same meaning as the word (keyword) obtained from the keyword extracting unit 51. For example, the synonym generating unit 52 utilizes the synonym dictionary (thesaurus) on which the synonym of each word is previously registered, and then generates the synonym for each keyword. The synonym generating unit 52 may generate a word shortening each keyword as the synonym. For example, the synonym generating unit 52 may generate a synonym “eco” for the keyword “ecology”, and a synonym “warming” for the keyword “global warming”.

The synonym generating unit 52 stores the generated synonym in the keyword DB 27 in association with the keyword that has been stored in the keyword DB 27 by the keyword extracting unit 51. Therefore, it is possible to store the synonym in the keyword DB 27 which has nearly the same meaning as the keyword extracted from the conference material data, as well as the extracted keyword. The keyword DB 27 may be configured to prepare two distinct storing regions, i.e., a keyword storing region and a synonym storing region, in association with each conference ID. Alternatively, the keyword DB 27 may be configured to prepare one storing region for storing the keyword treated by the keyword extracting unit 51 together with the synonym generated by the synonym generating unit 52, while recognizing the synonym as the keyword.

As described above, the keyword DB 27 according to the Embodiment 3 stores not only the keyword identified from the conference material but also the synonym of the identified keyword. Thus, the deciding unit 16 according to the Embodiment 3 compares each word obtained from the language analyzing unit 15 not only with the keywords stored in the keyword DB 27 but also with the synonyms of the keywords, to decide whether or not each sentence contains any keyword or any synonym. The deciding unit 16 reports the decision result to the totalizing unit 17, which represents whether or not each sentence contains any keyword or any synonym.

The keywords and synonyms for a conference may be registered on the keyword DB 27 before the conference is opened. Thus, it is not necessarily, immediately after the conference is reserved, to perform the registration processing of the keywords with the keyword extracting unit 51 and of the synonyms with the synonym generating unit 52. Therefore, it may be configured to perform all the keyword registration processing for plural conferences on the same day at proper time.

It will be described below about processing performed by the conference server 1 and the terminal apparatuses 4, 4, . . . in the conference system 100 according to the Embodiment 3. At the time when an user reserves a conference, the conference server 1 and the terminal apparatus 4 in the conference system 100 according to the Embodiment 3 perform the same processing illustrated in the Embodiment 1. Further, at the time when the conference server 1 relays the started teleconference after the reserved conference is opened by the registered user or the participants, the conference server 1 and the terminal apparatus 4 in the conference system 100 according to the Embodiment 3 perform the same processing illustrated in the Embodiment 1. Furthermore, for comprehending the state of the discussion with utilizing the keyword DB 27, the conference server 1 in the conference system 100 according to the Embodiment 3 performs the same processing illustrated in the Embodiment 1. However, the conference server 1 according to the Embodiment 3 utilizes not only the keywords stored in the keyword DB 27 but also the synonyms of the keywords, for comprehending the state of the conference.

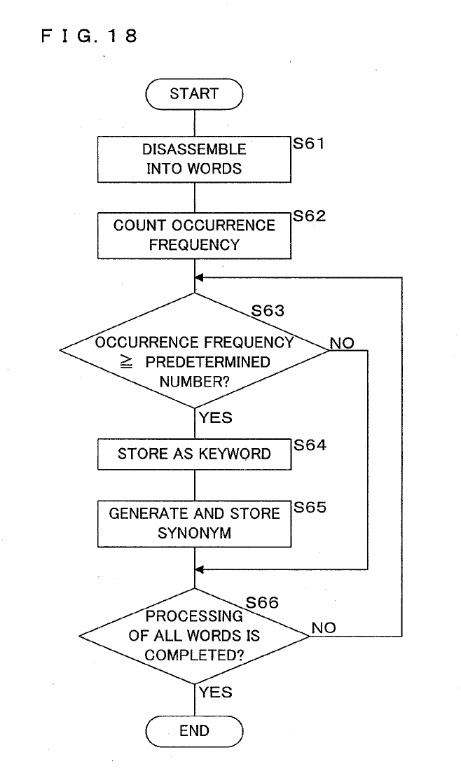

Next, it will be described about keyword registration processing based on conference materials, which is a significant function of the conference server 1 according to the Embodiment 3. FIG. 18 is a flowchart showing a procedure of keyword registration processing performed by the conference server 1. The control unit 10 of the conference server 1 performs the processing described below. At any time point after the conference is reserved and before the conference is opened, the control unit 10 of the conference server 1 according to the Embodiment 3 performs the keyword registration processing based on the conference materials, as described below.

The control unit 10 of the conference server 1 performs the language analysis processing on the conference material data utilized for the reserved conference, to disassemble into words (S61). The control unit 10 counts the occurrence frequency per word obtained by the disassembling processing (S62). The control unit 10 determines whether the counted frequency for each obtained word is not less than a predetermined number or not (S63). When having determined to be not less than the predetermined number (S63: YES), the control unit 10 stores the determined word as the keyword into the keyword DB 27 in association with the conference ID (S64).

The control unit 10 generates a synonym having nearly the same meaning as the word (keyword) stored in the keyword DB 27, and stores the generated synonym into the keyword DB 27 together with the keyword having been stored in the keyword DB 27 at the step S64 (S65). When having determined to be less than the predetermined number (S63: NO), the control unit 10 skips the processes at the step S64 and the step S65, and then determines whether or not the processing described above is completed for all words obtained by the disassembling processing at the step S61 (S66).

When having determined that the processing is not completed for all words (S66: NO), the control unit 10 returns the procedure to the step S63 and then determines whether the counted frequency for each word is not less than the predetermined number or not (S63). The control unit 10 repeats the processes from the step S63 to the step S65 until the processing for all words is completed. When having determined that the processing is completed for all words (S66: YES), the control unit 10 completes the procedure described above.

In the conference system 100 according to the Embodiment 3 described above, it is configured to automatically extract the keyword from the conference material and then to register the extracted keyword on the keyword DB 27, as the keyword is utilized for comprehending the state of the conference. Thus, it is not necessary for the registered user to input the keyword. Therefore, it is possible to reduce the work-load of the registered user.

The conference server 1 according to the Embodiment 3 is illustrated above to decide whether or not the speech contents of each participant contain any keyword or any synonym stored in the keyword DB 27, for deciding whether or not the discussion matches to the subject or not. In other words, the conference server 1 is illustrated to utilize the keyword equivalent to the synonym, as the keyword and the synonym are stored in the keyword DB 27. Alternatively, the conference server 1 may add different scores to the cumulative score between the case that the speech contents of each participant contains any keyword and the case that the speech contents of each participant contains any synonym. Thus, it is possible to weight the speech contents differently between the case that the speech contents of each participant contains any keyword and the case that the speech contents of each participant contains any synonym. Therefore, it is possible to perform the decision processing more accurately reflecting to the speech contents.

The conference server 1 according to the Embodiment 3 is illustrated above to set the keyword (including the synonym) of the conference based on the occurrence frequency for each word contained in the conference material. Alternatively, it may be configured to detect the font size of each word contained in the conference material, and then to register the word as the keyword whose font size is not less than a predetermined size. On a general conference material, the font size of each heading is highly expected to be larger than the font size of the other descriptions. Furthermore, each heading is highly expected to contain words to be treated as the keyword. Therefore, it is possible to find the keyword efficiently through the keyword setting processing based on the font size.

Although the Embodiment 3 is illustrated above to be a variation of the conference system 100 according to the Embodiment 1 described above, the aspect of the Embodiment 3 can be applied to the conference system 100 according to the Embodiment 2 described above. In short, the conference server 1 according to the Embodiment 3 can be configured to have the function for identifying the speaker originating the sound signals having received from the terminal apparatuses 4, 4, . . . .

In the Embodiments 1-3, the conference server 1 is illustrated above to decide whether or not each sentence of the speech contents of the respective participants contains any keyword (including synonym) stored in the keyword DB 27, and then to report the decision result to the terminal apparatuses 4, 4, . . . . However, it is not necessary to continuously report the decision result that the discussion matches to the subject. Therefore, it may be alternatively configured to alert only after the discussion is strayed from the subject for not less than a predetermined time period.

In the Embodiments 1-3, the conference server 1 is illustrated above to consider whether or not any keyword is contained in the sound signals transmitted among the terminal apparatuses 4, 4, . . . , and to decide in accordance with the consideration whether the discussion matches to the subject or not. Alternatively, it may be configured to utilize text information for deciding whether the discussion matches to the subject or not, as the text information (memo information) has been input by an user with the manipulating unit 34 of respective terminal apparatuses 4, 4, . . . and has been transmitted among the terminal apparatuses 4, 4, . . . at the teleconference.

In the Embodiments 1-3, the user information for identifying each user is illustrated above to be the user ID and the password. However, the present invention is not limited to such the illustration, and alternatively the user information may be information obtained from a business card of each user being read out by a scanner. In this alternative case, it is not required for each user to input own user information through the complicated input manipulation. Therefore, it is possible to enhance the usability. Specifically, it is possible to simplify the conference participating manipulation for a user (e.g., guest) who is not registered on the conference system 100.

In the Embodiments 1-3, the conference server 1 is illustrated above to decide whether or not any keyword is contained in each sentence of speech contents of the respective participants. In the case that the conference server 1 has the function for identifying the speaker as illustrated in the Embodiment 2, it may be alternatively configured to decide whether or not any keyword is contained in each speech of respective participants. In the case that the conference server 1 does not have the function for identifying the speaker as illustrated in the Embodiment 2, it may be alternatively configured to cause the control unit 10 of the conference server 1 to measure the passing time after each speaker completes a speech, and to determine that the speaker is changed after a predetermined time passes. Therefore, it is possible to decide whether or not any keyword is contained in each speech of the respective participants.

In the Embodiments 1-3, the conference server 1 is illustrated above to perform processing for comprehending the state of the discussion based on the sound signals transmitted among the terminal apparatuses 4, 4, . . . , while the conference is opened. Alternatively, it may be configured to cause the conference server 1 to start the decision processing for comprehending the discussion state, in response to the decision processing starting instruction given by the chairman or host (registered user) of the conference through the manipulating unit 34 of the terminal apparatus 4. Therefore, it is possible to decide whether the discussion matches to the subject or not, at arbitrary time period of the conference, such as the time period of Q&A session after a presentation of a speaker. The reason is that the presentation of the speaker is highly expected to match to the subject and then that the decision processing is not necessarily required during the presentation.

In the Embodiments 1-3, it is illustrated above to register Japanese words on the keyword DB 27. However, it may be alternatively configured to register foreign words, such as English words, on the keyword DB 27, and then to cause the conference server 1 to perform the sound recognition processing in a foreign language on the sound signals transmitted among the terminal apparatuses 4, 4, . . . . Therefore, even in the case that participants speak foreign languages, it is possible to perform similar processing.

The present invention is not limited to the above embodiments, although it is described above in detail about embodiments according to the present invention. A part of configurations and processes may be appropriately changed within the present invention.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A conference relay apparatus that is connected with plural communicating apparatuses to perform communications and relays a teleconference performed among the plural communicating apparatuses, comprising:
a storage unit that stores plural keywords;
a deciding unit that decides whether or not any keyword stored in the storage unit is contained in information transmitted/received among the communicating apparatuses; and
a state comprehending unit that comprehends a state of the teleconference on the basis of a result decided by the deciding unit.

2. The conference relay apparatus according to claim 1, further comprising;
a calculating unit that calculates a cumulative score, based on a score in the case that the deciding unit decides that any keyword stored in the storage unit is contained in the information and on a score in the case that the deciding unit decides any keyword stored in the storage unit is not contained in the information,
wherein the state comprehending unit comprehends the state of the teleconference on the basis of the cumulative score calculated by the calculating unit.

3. The conference relay apparatus according to claim 1, wherein
the information transmitted/received among the communicating apparatuses contains sound information,
the conference relay apparatus further comprises:
a sound recognizing unit that recognizes and converts the sound information contained in the information transmitted/received among the communicating apparatuses, into text information, and
the deciding unit decides whether or not any of the keywords is contained in the text information converted by the sound recognition unit.

4. The conference relay apparatus according to claim 1, wherein
the information transmitted/received among the communicating apparatuses contain text information, and
the deciding unit decides whether or not any of the keywords is contained in the text information transmitted/received among the communicating apparatuses.

5. The conference relay apparatus according to claim 1, further comprising:
a synonym storage unit that stores synonyms of keywords stored in the storage unit,
wherein the deciding unit decides whether or not any of the keywords stored in the storage unit and the synonyms stored in the synonym storage unit is contained in the information transmitted/received among the communicating apparatuses.

6. The conference relay apparatus according to claim 1, further comprising:
a notifying unit that notifies a result comprehended by the state comprehending unit.

7. The conference relay apparatus according to claim 1, wherein
the state comprehending unit determines whether or not the state of the teleconference is strayed from a predetermined content including the keyword, and
the conference relay apparatus further comprises:
a reporting unit that reports an intention that the state of the teleconference should match to the predetermined content, in the case that the state of the teleconference is determined by the state comprehending unit to be strayed from the predetermined content.

8. The conference relay apparatus according to claim 1, further comprising:
an extracting unit that extracts a word from the information transmitted/received among the communicating apparatuses;
an occurrence frequency counting unit that counts an occurrence frequency of the word extracted by the extracting unit; and
a registering unit that registers a word whose occurrence frequency counted by the occurrence frequency counting unit is not less than a predetermined number, as a keyword, on the storage unit.

9. A conference system, comprising:
plural communicating apparatuses; and
a conference relay apparatus that is connected with the plural communicating apparatuses to perform communications and relays a teleconference performed among the plural communicating apparatuses, wherein
the conference relay apparatus includes:
a storage unit that stores plural keywords;
a deciding unit that decides whether or not any keyword stored in the storage unit is contained in information transmitted/received among the communicating apparatuses; and
a state comprehending unit that comprehends a state of the teleconference on the basis of a result decided by the deciding unit.

10. The conference system according to claim 9, wherein
the conference relay apparatus further includes:
a calculating unit that calculates a cumulative score, based on a score in the case that the deciding unit decides that any keyword stored in the storage unit is contained in the information and on a score in the case that the deciding unit decides any keyword stored in the storage unit is not contained in the information, and
the state comprehending unit comprehends the state of the teleconference on the basis of the cumulative score calculated by the calculating unit.

11. The conference system according to claim 9, wherein
the information transmitted/received among the communicating apparatuses contains sound information,
the conference relay apparatus further includes:
a sound recognizing unit that recognizes and converts the sound information contained in the information transmitted/received among the communicating apparatuses, into text information, and
the deciding unit decides whether or not any of the keywords is contained in the text information converted by the sound recognition unit.

12. The conference system according to claim 9, wherein
the information transmitted/received among the communicating apparatuses contains text information, and
the deciding unit decides whether or not any of the keywords is contained in the text information transmitted/received among the communicating apparatuses.

13. The conference system according to claim 9, wherein
the conference relay apparatus further includes:
a synonym storage unit that stores synonyms of keywords stored in the storage unit, and
the deciding unit decides whether or not any of the keywords stored in the storage unit and the synonyms stored in the synonym storage unit is contained in the information transmitted/received among the communicating apparatuses.

14. The conference system according to claim 9, wherein
the conference relay apparatus further includes:
a notifying unit that notifies the communicating apparatuses of a result comprehended by the state comprehending unit.

15. The conference system according to claim 9, wherein
the state comprehending unit determines whether or not the state of the teleconference is strayed from a predetermined content including the keyword, and
the conference relay apparatus further includes:
a reporting unit that reports to the communicating apparatuses an intention that the state of the teleconference should match to the predetermined content, in the case that the state of the teleconference is determined by the state comprehending unit to be strayed from the predetermined content.

16. The conference system according to claim 9, wherein
the conference relay apparatus further includes:
an extracting unit that extracts a word from the information transmitted/received among the communicating apparatuses;
an occurrence frequency counting unit that counts an occurrence frequency of the word extracted by the extracting unit; and
a registering unit that registers a word whose occurrence frequency counted by the occurrence frequency counting unit is not less than a predetermined number, as a keyword, on the storage unit.

17. A non-transitory computer readable medium that stores a computer program for relaying a teleconference performed among plural communicating apparatuses which are connected to perform communications, the computer program comprising steps of:
causing a computer to decide whether or not any of plural keywords is contained in information transmitted/received among the communicating apparatuses; and
causing the computer to comprehend a state of the teleconference on the basis of the decision result.
